(19) United States
(12) Patent Application Publication
(10) Pub. No.: US 2015/0268010 A1
(43) Pub. Date: Sep. 24, 2015

(54) STRUCTURAL BALLISTIC RESISTANT APPARATUS

(71) Applicant: ANGEL ARMOR, LLC, Fort Collins, CO (US)

(72) Inventor: Eric B. Strauss, Fort Collins, CO (US)

(21) Appl. No.: 14/684,365

(22) Filed: Apr. 11, 2015

Related U.S. Application Data
(63) Continuation-in-part of application No. 13/353,185, filed on Jan. 18, 2012.
Application No. 13/353,185 is a continuation-in-part of application No. 14/539,259, filed on Nov. 12, 2014.
Application No. 14/539,259 is a continuation-in-part of application No. 14/599,539, filed on Jan. 18, 2015.
(60) Provisional application No. 61/978,342, filed on Apr. 11, 2014.
(60) Provisional application No. 62/012,959, filed on Jun. 16, 2014.
(60) Provisional application No. 61/461,586, filed on Jan. 19, 2011.
(60) Provisional application No. 61/903,353, filed on Nov. 12, 2013.

(51) Int. Cl. F41H 7/04; B32B 27/12; B32B 27/32; B32B 5/12; B32B 5/02; F41H 5/04; B32B 7/12

(52) U.S. Cl. CPC F41H 7/044; F41H 5/0478; B32B 27/12; B32B 7/12; B32B 5/12; B32B 5/022; B32B 5/024; B32B 27/32; B32B 2571/02; B32B 2605/00; B32B 2262/106; B32B 2262/101; B32B 2255/02; B32B 2255/26

(57) ABSTRACT

A structural ballistic resistant vehicle door can replace an original vehicle door when armoring a vehicle, such as a civilian, military, or law enforcement vehicle. The structural ballistic resistant vehicle door can include a stack of laminated ballistic sheets that include high-performance fibers. During a manufacturing process, the stack of ballistic sheets can be exposed to heat and pressure to compress the stack and improve ballistic performance. A structural composite layer can encase and protect the laminated stack of ballistic sheets. The structural composite layer can be made of a carbon fiber composite material or a fiberglass composite material.

### CROSS-REFERENCE TO RELATED APPLICATIONS

This application claims the benefit of U.S. Provisional Patent Application No. 61/978,342 filed Apr. 11, 2014 and U.S. Provisional Patent Application No. 62/012,959 filed on Jun. 16, 2014, and is a continuation-in-part of a continuation-in-part of U.S. patent application Ser. No. 14/539,259 filed Nov. 12, 2014, which claims the benefit of U.S. Provisional Patent Application No. 61/903,353 filed Nov. 12, 2013, and is continuation-in-part of U.S. patent application Ser. No. 13/353,185 filed Jan. 18, 2012, which claims the benefit of U.S. Provisional Patent Application No. 61/461,586 filed Jan. 19, 2011, and is a continuation-in-part of U.S. patent application Ser. No. 14/599,539 filed Jan. 18, 2015, all of which are hereby incorporated by reference in their entirety as if fully set forth in this description.

### FIELD OF THE INVENTION

This disclosure relates to structural ballistic resistant apparatuses and systems and methods for manufacturing structural ballistic resistant apparatuses.

### BACKGROUND

Military, civilian, and law enforcement vehicles can be equipped with armor plating to protect vehicle occupants from ballistic threats, such as projectiles or blasts. Armor plating is commonly made of steel, which is a very heavy material. When steel plating is added to a vehicle, the weight of the vehicle increases significantly. To ensure adequate performance of the vehicle after installation of steel plating, the suspension of the vehicle may need to be upgraded, and depending on the weight of the steel plating, the chassis of the vehicle may also need to be upgraded, for example, by welding additional structural members to the frame, which can be costly and labor-intensive. These modifications alter the appearance of the vehicle, making the vehicle easily identifiable as an armored vehicle by adversaries, which can jeopardize the safety of vehicle occupants and make the vehicle unfit for covert missions.

### BRIEF DESCRIPTIONS OF DRAWINGS

FIG. 1 shows a light tactical military vehicle with ballistic resistant doors.

FIG. 2 shows a civilian vehicle modified to include ballistic resistant doors.

FIG. 3A shows a front view of an original vehicle door for a civilian vehicle.

FIG. 3B shows a rear view of the original vehicle door of FIG. 3A revealing a trim panel and various door components.

FIG. 3C shows a rear view of the original vehicle door of FIG. 3A after the trim panel and various door components have been removed.

FIG. 4 shows a mold for making a ballistic resistant vehicle door to replace an original vehicle door.

FIG. 5 shows a front perspective view of a portion of a ballistic resistant vehicle door for a civilian vehicle.

FIG. 6 shows a top perspective view of the portion of the ballistic resistant vehicle door of FIG. 5

FIG. 7 shows a front view of a ballistic resistant vehicle door including window glass, a side mirror, and a door handle.

FIG. 8 shows a rear perspective view of the ballistic resistant vehicle door of FIG. 7 with a trim panel and interior door components removed.

FIG. 9A shows a cross-sectional top view of a first ballistic resistant vehicle door of FIG. 7 taken along section A-A, the door having an inner door structure including ballistic resistant sheet encased by structural members, an outer door structure including ballistic resistant sheets encased by structural members, and a trim panel, where the inner door structure is spaced apart from the outer door structure by a distance.

FIG. 9B shows an exploded cross-sectional top view of the ballistic resistant door of FIG. 9A, the door having an inner door structure including ballistic resistant sheet encased by structural members, an outer door structure including ballistic resistant sheets encased by structural members, and a trim panel.

FIG. 10 shows a cross-sectional top view of a second ballistic resistant vehicle door taken along section A-A of FIG. 7.

FIG. 11 shows a cross-sectional view of a third ballistic resistant vehicle door taken along section A-A of FIG. 7, the third ballistic resistant vehicle door having an outer door structure including ballistic resistant sheets encased by structural members.

FIG. 12 shows a front perspective view of an outer door structure for a ballistic resistant vehicle door, the outer door structure having stack of ballistic resistant sheets encased by a first structural member mated to a second structural member.

FIG. 13 shows a rear perspective view of the outer door structure of FIG. 12.

FIG. 14 shows an array of hexagonal ceramic members arranged to eliminate any gaps between adjacent ceramic members.

FIG. 15 shows a cross sectional view of a door structure including ceramic members arranged to provide a curved array with no gaps between adjacent ceramic members, the ceramic members encased by a structural layer made of a carbon fiber composite material.

FIG. 16 shows a cross-sectional view of a fourth ballistic resistant vehicle door taken along section A-A of FIG. 7, the fourth ballistic resistant vehicle door having an outer door structure including ceramic members encased by structural members and an inner door structure including ballistic resistant sheets encased by structural members, where the inner door structure is spaced apart from the outer door structure by a distance.

FIG. 17 shows a cross-sectional view of a fifth ballistic resistant vehicle door taken along section A-A of FIG. 7, the fifth ballistic resistant vehicle door having an outer door structure including ceramic members and ballistic resistant sheets encased by structural members and an inner door structure including ballistic resistant sheets encased by structural members, where the inner door structure is spaced apart from the outer door structure by a distance.

FIG. 18 shows a vacuum bagging process for making an inner door structure using the mold of FIG. 4, the process including arranging the ballistic sheets and composite layers in a mold cavity, creating a sealed volume by adhering a vacuum bagging film around a perimeter of the mold cavity with a sealant tape, and evacuating air from the sealed volume using a vacuum hose attached to a vacuum source.

FIG. 19 shows a side cross-sectional view of FIG. 18 taken along section B-B and exposing ballistic sheets, composite layers, and a breather layer between the vacuum bagging film and the mold surface.

### SUMMARY

This disclosure relates to structural ballistic resistant vehicle doors and systems and methods for manufacturing structural ballistic resistant vehicle doors.

In one example, a structural ballistic resistant vehicle door can include an inner door structure joined to an outer door structure. The inner door structure can include a rigid carbon fiber composite material or a rigid fiberglass composite material. The outer door structure can be spaced apart from the inner door structure by a distance. The outer door structure can include a stack of ballistic sheets. The stack can include a top surface and a bottom surface opposite the top surface. One or more ballistic sheets in the stack of ballistic sheets can be partially or fully bonded to an adjacent ballistic sheet in the stack of ballistic sheets. The outer door structure can include a first structural member adjacent to the top surface of the stack of ballistic sheets. The first structural member can include a rigid carbon fiber composite material or a rigid fiberglass composite material. The outer door structure can include a second structural member adjacent to the bottom surface of the stack of ballistic sheets. The second structural member can include a rigid carbon fiber composite material or a rigid fiberglass composite material. The second structural member can be joined to the first structural member to form a three-dimensional structural exterior layer that encapsulates the stack of ballistic sheets. The door can include a first film adhesive layer between the first structural member and the top surface of the stack of ballistic sheets. The first film adhesive layer can include a thermoplastic polymer and can adhere the first structural member to the top surface of the stack of ballistic sheets. The door can include a second film adhesive layer between the second structural member and the bottom surface of the stack of ballistic sheets. The second film adhesive layer can include a thermoplastic polymer and can adhere the second structural member to the bottom surface of the stack of ballistic sheets. The structural ballistic resistant vehicle door can include a first structural member and the second structural member. The first and second structural members can each include woven or nonwoven carbon fiber fabric impregnated with an epoxy resin. The stack of ballistic sheets can include about 10-25, 20-100, 80-220, 200-260, 250-500, or 450-1,200 ballistic sheets. The ballistic sheets within the stack of ballistic sheets can be high modulus bidirectional pre-impregnated composite sheets. The structural ballistic resistant vehicle door can have a ballistic performance that meets or exceeds threat level III requirements set forth in NIJ Standard 0108.01. One or more ballistic sheets within the stack of ballistic sheets can include ultra-high-molecular-weight polyethylene having an average molecular weight of about two million to six million. The inner door structure can include a second stack of ballistic sheets. The second stack can include a top surface and a bottom surface opposite the top surface. One or more ballistic sheets in the second stack of ballistic sheets can be partially or fully bonded to an adjacent ballistic sheet in the stack of ballistic sheets. The inner door structure can include a third structural member adjacent to the top surface of the second stack of ballistic sheets. The third structural member can include a rigid carbon fiber composite material or a rigid fiberglass composite material. The inner door structure can include a fourth structural member adjacent to the bottom surface of the stack of ballistic sheets. The fourth structural member can include a rigid carbon fiber composite material or a rigid fiberglass composite material. The fourth structural member can be joined to the third structural member to form a three-dimensional structural exterior layer that encapsulates the second stack of ballistic sheets. The distance between the inner door structure and the outer door structure can be about 0.5-3, 2-6, 4-12, or 10-18 inches. The distance can be at least two times greater than a length of a projectile the structural ballistic resistant door is intended to protect against.

In another example, a structural ballistic resistant vehicle door can include a stack of ballistic sheets. The stack can include a top surface and a bottom surface opposite the top surface. One or more ballistic sheets in the stack of ballistic sheets can be partially or fully bonded to an adjacent ballistic sheet in the stack of ballistic sheets. The door can include a first structural member adjacent to the top surface of the stack of ballistic sheets. The first structural member can include a rigid carbon fiber composite material or a rigid fiberglass composite material. The door can include a second structural member adjacent to the bottom surface of the stack of ballistic sheets. The second structural member can include a rigid carbon fiber composite material or a rigid fiberglass composite material. The second structural member can be joined to the first structural member to form a three-dimensional structural exterior layer that encapsulates the stack of ballistic sheets. The first and second structural members can provide a compressive force against opposing exterior surfaces of the stack of ballistic sheets to resist delamination of the stack of ballistic sheets when the structural ballistic resistant vehicle door is struck by a projectile. The stack of ballistic sheets can include about 10-20, 20-100, at least 100, 180-220, 220-260, at least 260, 260-500, 500-1,000, or 1,000-1,200 ballistic sheets. One or more ballistic sheets within the stack of ballistic sheets can include aramid fibers arranged unilaterally. The structural ballistic resistant vehicle door can have a ballistic performance that meets or exceeds threat level III requirements set forth in NIJ Standard 0108.01. One or more ballistic sheets within the stack of ballistic sheets can include ultra-high-molecular-weight polyethylene having an average molecular weight between about two million and six million. The door can include a first film adhesive layer between the first structural member and the top surface of the stack of ballistic sheets. The first film adhesive layer can include a thermoplastic polymer. The door can include a ceramic member positioned between the first structural member and the top surface of the stack of ballistic sheets. The ceramic member can include silicon carbide, boron carbide, titanium carbide, tungsten carbide, zirconia toughened alumina, or high-density aluminum oxide. The door can include a plurality of ceramic members arranged in an array between the first structural member and the top surface of the stack of ballistic sheets. The structural ballistic resistant vehicle door can have a ballistic performance that meets or exceeds threat level IV requirements set forth in NIJ Standard 0108.01.

In yet another example, a structural ballistic resistant vehicle door can include an outer door structure. The outer door structure can include a rigid carbon fiber composite material or a rigid fiberglass composite material. The door can include an inner door structure joined to the outer door structure to form the structural ballistic resistant vehicle door. The inner door structure can include a stack of ballistic sheets. The stack can include a top surface and a bottom surface opposite the top surface. One or more ballistic sheets in the stack of ballistic sheets can be partially or fully bonded to an adjacent ballistic sheet in the stack of ballistic sheets. The inner door structure can include a first structural member adjacent to the top surface of the stack of ballistic sheets. The first structural member can include a rigid carbon fiber composite material or a rigid fiberglass composite material. The inner door structure can include a second structural member adjacent to the bottom surface of the stack of ballistic sheets. The second structural member can include a rigid carbon fiber composite material or a rigid fiberglass composite material. The second structural member can be joined to the first structural member to form a three-dimensional structural exterior layer that encapsulates the stack of ballistic sheets. The stack of ballistic sheets can include about 10-20, 20-100, at least 100, 180-220, 220-260, at least 260, 260-500, 500-1,000, or 1,000-1,200 ballistic sheets. One or more ballistic sheets within the stack of ballistic sheets can include ultra-high-molecular-weight polyethylene having an average molecular weight between about two million and six million. One or more ballistic sheets within the stack of ballistic sheets can include aramid fibers arranged unilaterally. The door can include a first film adhesive layer between the first structural member and the top surface of the stack of ballistic sheets. The first film adhesive layer can include polyethylene, polypropylene, ethylene, copolyester, copolyamide, or thermoplastic polyurethane. The first film adhesive layer can adhere the first structural member to the top surface of the stack of ballistic sheets. The door can include a second film adhesive layer between the second structural member and the bottom surface of the stack of ballistic sheets. The second film adhesive layer can include polyethylene, polypropylene, ethylene, copolyester, copolyamide, or thermoplastic polyurethane. The first adhesive film layer can adhere the second structural member to the bottom surface of the stack of ballistic sheets. The outer door structure can include a ceramic member encased by a structural member. The structural member can include a woven or nonwoven carbon fiber fabric infused with a thermoset resin. The structural ballistic resistant vehicle door can have a ballistic performance that meets or exceeds threat level III requirements set forth in NIJ Standard 0108.01.

Additional objects and features of the invention are introduced below in the Detailed Description and shown in the drawings. While multiple embodiments are disclosed, still other embodiments will become apparent to those skilled in the art from the following Detailed Description, which shows and describes illustrative embodiments. As will be realized, the disclosed embodiments are susceptible to modifications in various aspects, all without departing from the scope of the present disclosure. Accordingly, the drawings and detailed description are to be regarded as illustrative in nature and not restrictive.

This Summary is provided to introduce a selection of concepts in a simplified form that are further described in the Detailed Description below. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DETAILED DESCRIPTION

Lightweight, high-performing structural armor is described herein that, unlike steel armor, does not degrade handling or fuel economy of vehicles in which it is installed. A civilian vehicle that has been fitted with the armor described herein looks and behaves like a standard civilian vehicle. This allows the vehicle to participate in covert operations (e.g. surveillance, tactical strikes, or food and aid delivery in hostile regions) without being identified as an armored vehicle and targeted by adversaries.

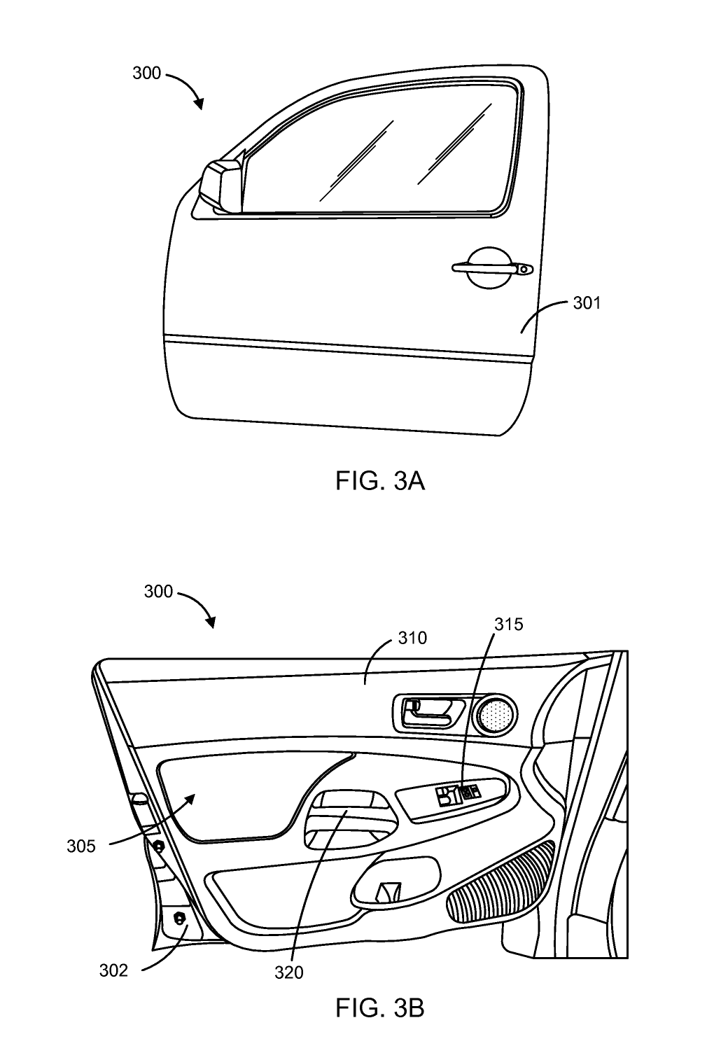

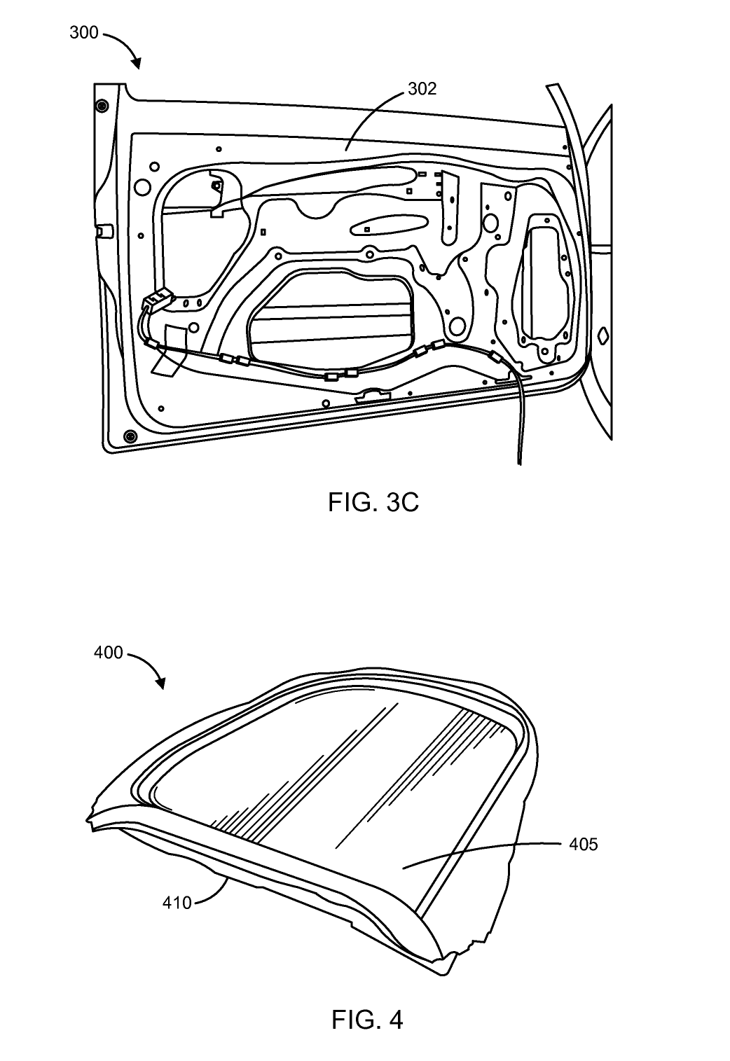

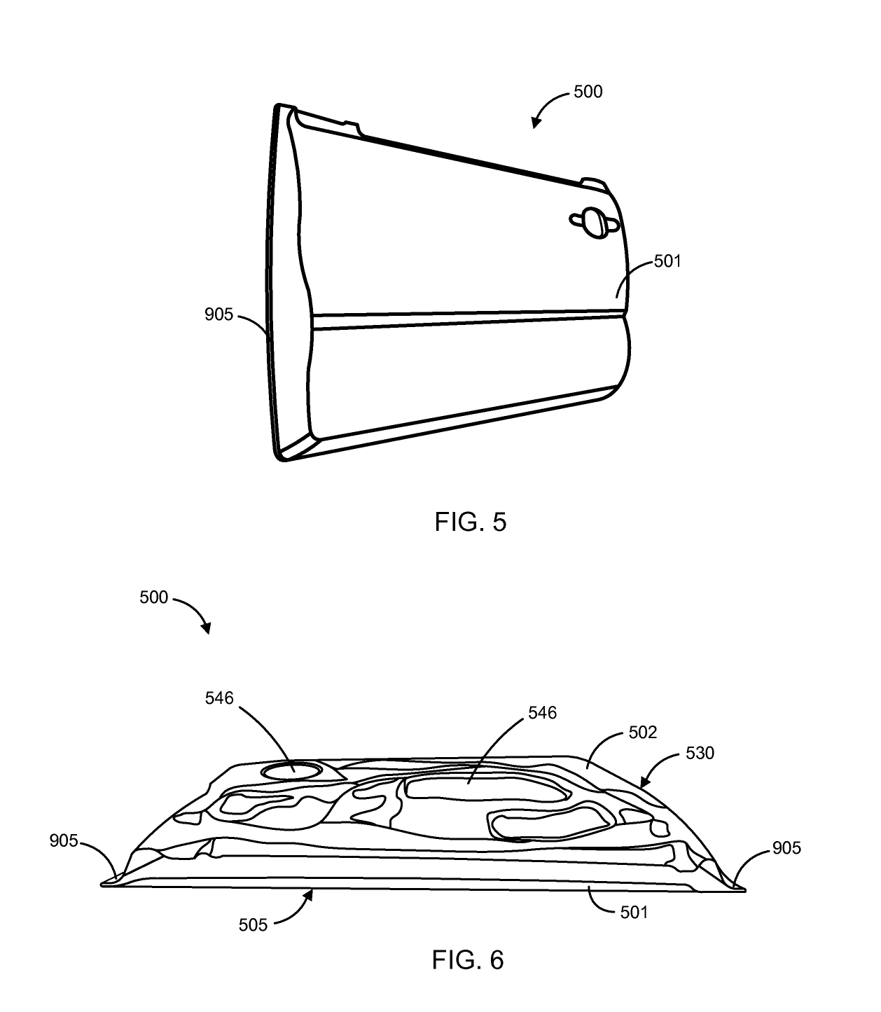

During a conversion process, original vehicle doors 300, as shown in FIGS. 3A-3C, can be removed from a civilian vehicle 200 and replaced with ballistic resistant vehicle doors 500, as shown in FIGS. 5-11. The ballistic resistant vehicle doors 500 can be manufactured to look nearly identical to the original doors 300 they replace, including color-matched paint and clear coat, window glass, side mirrors, and door handles. Upon visual inspection of the ballistic resistant vehicle doors 500, a person (e.g. a guard at a checkpoint) may not recognize that the doors 500 are equipped with ballistic protection, thereby permitting the vehicle to be used for covert operations without jeopardizing the safety of vehicle occupants. In instances where additional ballistic protection is needed, other portions of the vehicle, such as the cab 575 (e.g. roof, floor, firewall, A-pillar, B-pillar, etc.), hood 585, tailgate 580, and other body panels, can be replaced with ballistic resistant structures made with the materials and processes described herein.

Military conflicts often occur in remote regions of the world where infrastructure is inadequate or absent. Roads may be narrow and unpaved, and bridges may not be capable of withstanding the weight of heavily armored vehicles, such as tanks or High Mobility Multipurpose Wheeled Vehicles (HMMWV) manufactured by AM General of South Bend, Ind. Where steel plating is used to armor a HMMWV, it is not uncommon for the vehicle's weight to approach 7,000 pounds and for the vehicle's width to increase by up to two feet, resulting in a vehicle that is nearly 9 feet wide. For these reasons, heavily armored vehicles are not ideal in many remote regions of the world. In addition, steel-armored doors are so heavy that a mechanical assist device is often required to open the door, especially when the vehicle overturns and an occupant is trapped inside the vehicle and attempting to escape the wreckage.

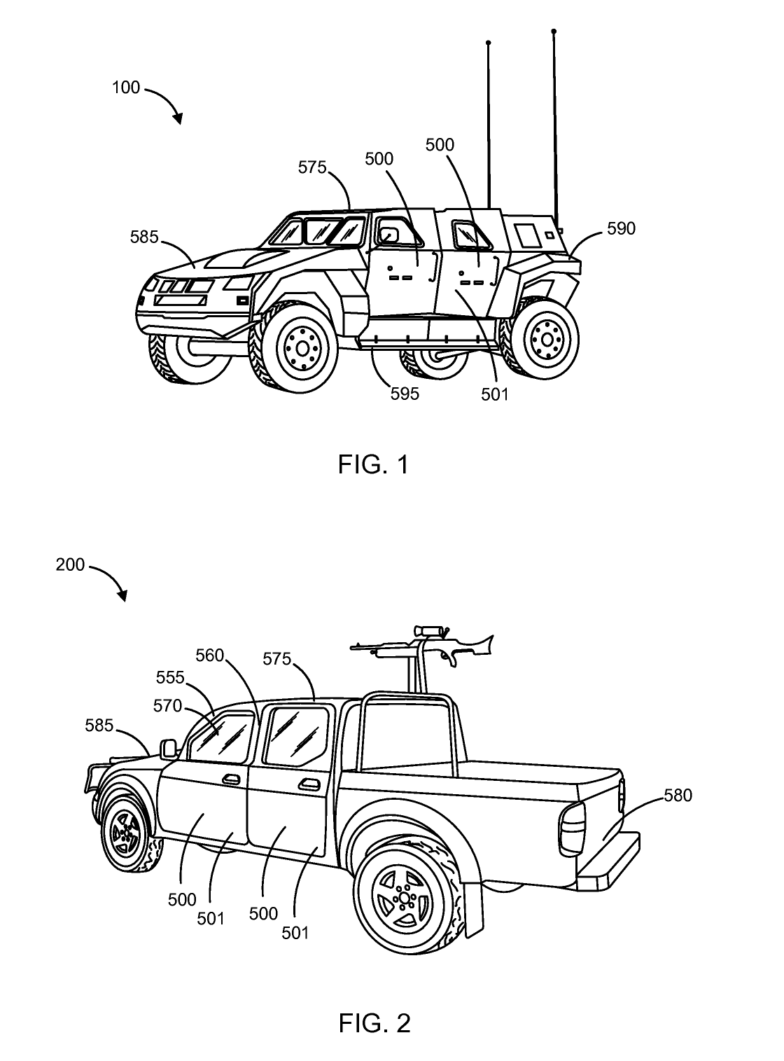

To provide greater mobility in remote regions, heavily armored vehicles can be replaced with light tactical vehicles that can safely travel on existing infrastructures. These light tactical vehicles can be equipped with lightweight, ballistic resistant doors 500, as described herein, that are easy to open and close without requiring a mechanically assist device. In one example, these light vehicles can be Joint Light Tactical Vehicles (JLTV) 100, such as the various JLTV concepts developed by BAE Systems, Navistar, Oshkosh Corporation, Northrop Grumman, General Dynamics Land Systems, AM General, Boeing, or Lockheed Martin. The JLTV 100 can be modified to include ballistic protection, such as ballistic resistant vehicle doors 500 as shown in FIG. 1. In some examples, the JLTV 100 can also be modified to include a ballistic resistant cab 575, hood 585, fenders 590, and/or chassis 595. These components can be manufactured using a similar process as the ballistic resistant doors 500 described herein.

In another example, light tactical vehicles can be commercially-available civilian vehicles 200, as shown in FIG. 2, that have been modified to include ballistic protection, such as ballistic resistant doors 500, cabs 575, tailgates 580, hoods 585, and/or chassis members, as described herein. Specifically, a commercially-available TOYOTA TACOMA (or HILUX as the model is known outside of North America) with a 4-wheel drive transmission can be modified to include ballistic protection by uninstalling the original doors 300 and replacing them with lightweight ballistic resistant doors 500 as described herein, thereby creating an armored vehicle that can actually weigh less than a stock TACOMA, which has a curb weight of about 4,200 pounds for a double cab model as shown in FIG. 2. Reducing the weight of an armored vehicle is highly desirable, because it makes the vehicle more fuel-efficient (which extends the vehicle's range on a single tank of fuel) and it reduces the cost of transporting the vehicle (e.g. via freighter or transport plane) to a remote region where it will be utilized. As described herein, the original vehicle doors 300 can be used to create three-dimensional vehicle door molds 400 (as shown in FIG. 4) that facilitate the manufacture of ballistic resistant vehicle doors 500 that are dimensionally similar to the original vehicle doors 300.

Commercially-available vehicles 200 can be purchased at a relatively low cost compared to heavily armored vehicles. For instance, a TOYOTA TACOMA can be purchased for about twenty percent of the cost of an armored HMMWV, and due to higher vehicle inventories, may be more readily available. Also, the ballistic resistant doors 500 described herein can be manufactured and installed on commercially-available vehicles 200 for a relatively low cost with simple hand tools, such as ratchets and screw drivers. As a result, a commercially-available vehicle 200 can be upgraded with ballistic resistant doors 500, as shown in FIG. 2, at a cost far below the cost of purchasing a heavily armored vehicle and can be mobilized much faster. Moreover, the installation of the ballistic resistant vehicle doors 500 can be accomplished in the field with simple hand tools, thereby making this armor solution highly desirable for covert missions where more sophisticated equipment, such as welding units, hydraulic vehicle lifts, and drill presses required for installing steel armor plating is unavailable.

In addition to lower cost and ease of installation, the upgraded commercially-available vehicle 200 can also offer enhanced mobility (e.g. on narrow roads and weakly supported bridges), thereby making the upgraded vehicle more desirable for many military operations than a heavily armored vehicle.

A ballistic resistant vehicle door 500, as shown in FIGS. 1, 2, and 5-11, can provide protection from ballistic threats, such as projectiles and blasts. FIG. 5 shows a front perspective view of a lower portion of the ballistic resistant vehicle door 500 for a civilian vehicle 200, and FIG. 6 shows a top perspective view of the same door. FIGS. 5 and 6 show the ballistic resistant vehicle door 500 prior to installation of any door components, such as window glass, trim panels, seals, A-pillar, B-pillar, wiring harness, mirrors, speakers, or power lock and window controls. The structural ballistic resistant vehicle door 500 can include an outer door structure 505 joined to an inner door structure 530 and a gap provided therebetween to accommodate window glass 570 and various door components, such as a door latch and locking mechanism.

FIG. 8 shows the ballistic resistant vehicle door 500 after installation onto the vehicle 200 but prior to installation of a trim panel 550 designed to conceal the internal door components. As shown in FIGS. 6 and 8, the inner door structure 530 can include openings 546 to accommodate installation of various door components, including mechanisms for raising and lowering the widow glass 570, one or more speakers, and electronics for power window and door lock systems.

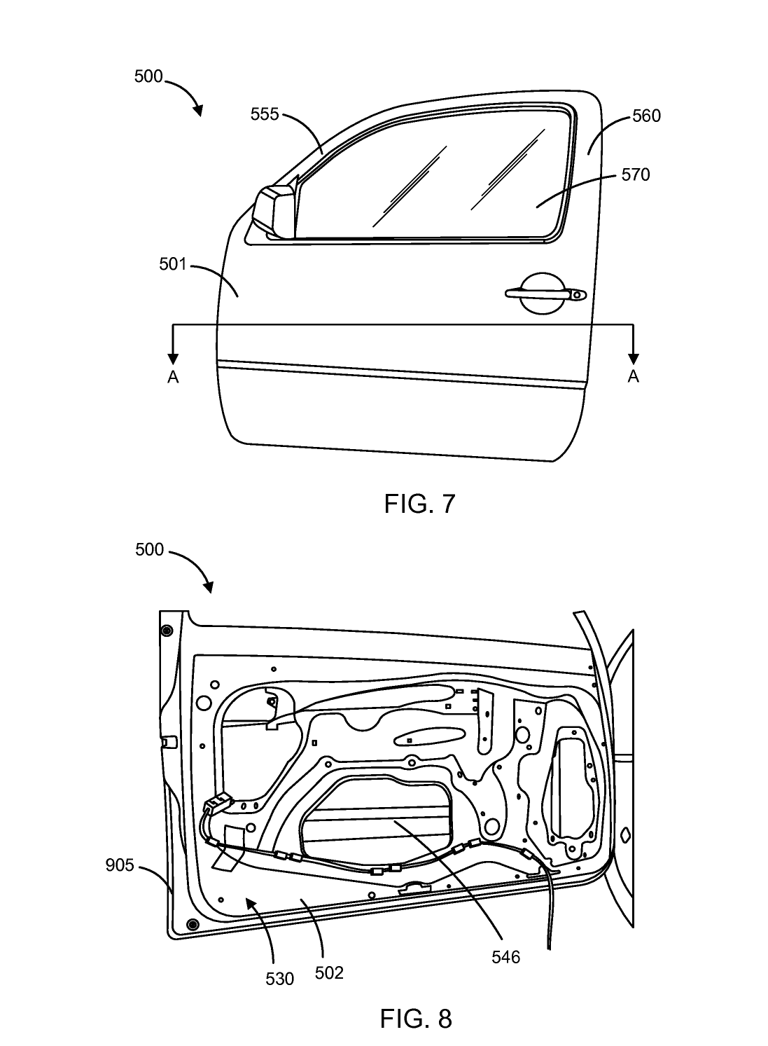

FIG. 7 shows a front view of a ballistic resistant door 500 having both a lower portion and an upper portion, where the joint between the lower and upper portion is seamless and undetectable after paint and clear coat is applied. The upper portion of the vehicle door 500 can include an A-pillar 550, B-pillar 560, and tracks formed in the A and B-pillars that support the window glass 570 and permit the glass to slide up and down as the window is closed and opened, respectively. In some instances, the upper portion of the vehicle door can be formed as an integral portion of the door 500. In other instances, the upper portion can be formed separately (i.e. as a subcomponent) and joined to the lower portion using adhesives, carbon fiber composite layups, fasteners, and/or any other suitable joining technique to create a complete and seamless ballistic resistant door 500.

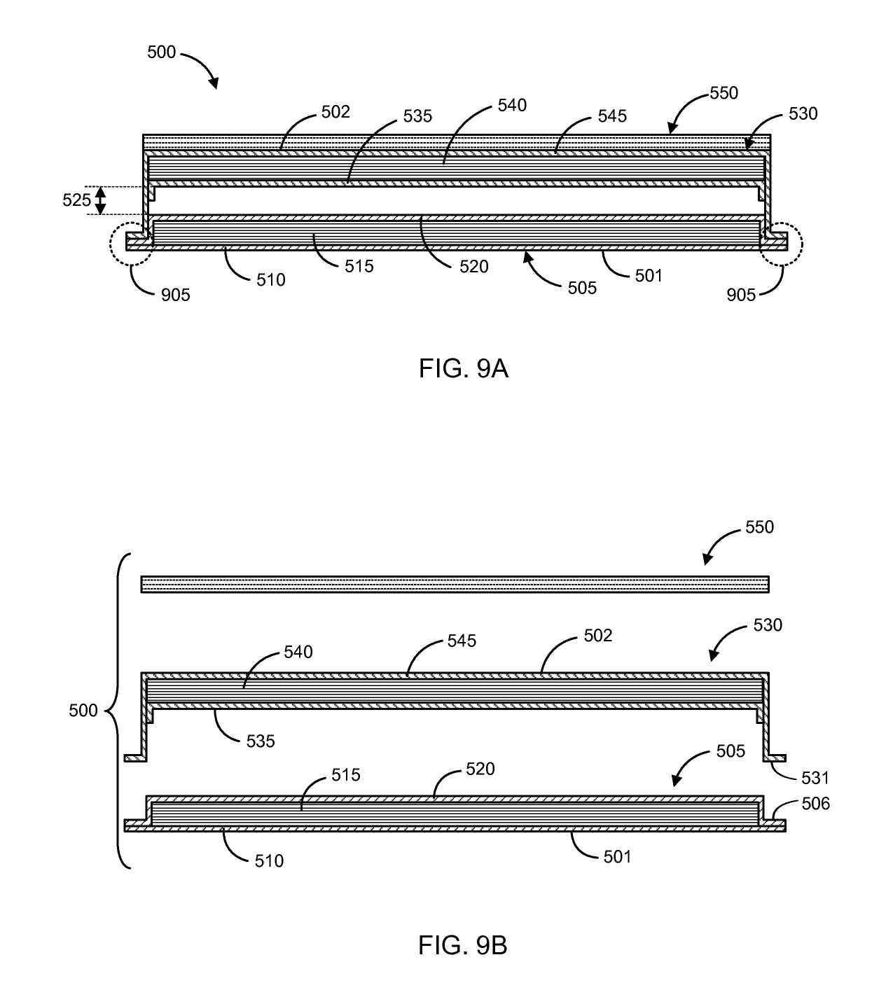

The ballistic resistant vehicle door 500 can include a plurality of ballistic sheets arranged to form two or more stacks of ballistic resistant sheets (e.g. 515, 540), as shown in FIGS. 9A, 9B, where a first stack 515 of ballistic resistant sheets is spaced apart a distance 525 from a second stack 540 of ballistic resistant sheets. Prior to or after arranging the ballistic sheets to form a stack, the ballistic sheets can be trimmed to a size and shape that is appropriate for use in a ballistic resistant vehicle door 500. In one example, a cutting table can be used to quickly and accurately trim the ballistic sheets into desired sizes and shapes. An example of a suitable cutting table is a M9000 Static Cutting Table, manufactured by Eastman Machine Company of Buffalo, N.Y. To prevent the ballistic sheets from moving during a cutting process, the cutting table can be equipped with a vacuum system. The vacuum system can include a plenum located beneath the cutting table, and the plenum can be in fluid communication with small holes or openings in the cutting table. The vacuum system can include a vacuum pump in fluid communication with the vacuum chamber. When the vacuum pump is operating, it can draw air through the holes or openings in the cutting table, into the vacuum chamber, and through the vacuum pump. When a sheet of fabric is being cut on the cutting table, operation of the vacuum pump produces a partial vacuum in the vacuum chamber, which provides suction force on a top surface of the cutting table. The suction force prevents the material from moving during the cutting process, thereby improving cutting precision.

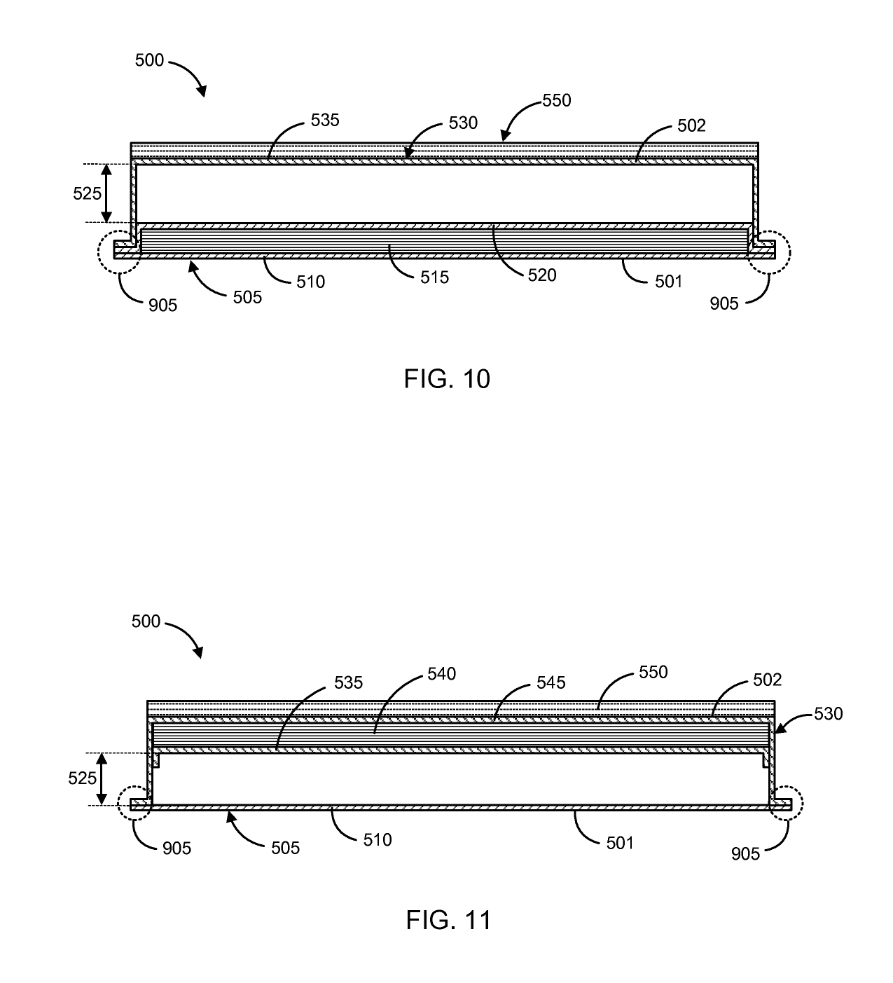

In some examples (see, e.g. FIG. 10), the ballistic resistant vehicle door 500 can include at least one stack of ballistic sheets (e.g. 515) encased between a first structural member (e.g. 510) and a second structural member (e.g. 520). The term “structural member” as used herein can describe any suitable layer or layers having any suitable shape or shapes (e.g. flat, curved, or complexly curved) and any suitable dimensions. A structural member 510, as shown in FIG. 11, can replace a sheet metal part commonly used as a structural portion of an original (i.e. OEM) vehicle door 300 (see, e.g., the sheet metal exterior surface 302 or sheet metal interior surface 301 shown in FIGS. 3A and 3C, respectively. The stack of ballistic sheets (e.g. 515) encased between the first and second structural members (e.g. 510, 520) can form an outer door structure 505 that can bolster the stiffness of the ballistic resistant vehicle door 500 (see, e.g. FIGS. 9A, 9B, and 10) and, as a result, can improve the vehicle door's ability to withstand torsional, compressive, or tensile forces.

In some examples, the structural member (e.g. 510, 520) can be made of a composite material. The composite material can include fabric combined with resin. The fabric can be constructed from graphite fiber (commonly referred to as “carbon fiber”), glass fiber, KEVLAR fiber, carbon nanotubes, or any other suitable high-performance fiber, combination of fibers, or material. In some examples, the fabric can be a hybrid of two or more types of fibers, such as a hybrid fabric made of carbon fibers and aramid fibers. The fabric can be constructed as a woven, knitted, stitched, or nonwoven (e.g. uni-directional) fabric. Examples of suitable woven fabrics include Style 7725 Bi-directional E-Glass (Item No. 1094), Twill Weave Carbon Fiber Fabric (Item No. 1069), and KEVLAR Plain Weave Fabric (Item No. 2469), all available from Fibre Glast Developments Corporation of Brookville, Ohio.

In some instances, resin can be applied to the fabric during a lamination process, either by hand or through an infusion process. In other instances, the fabric can be pre-impregnated with resin. These fabrics are commonly referred to as “prepreg” fabrics. Prepreg fabrics may require cold storage to ensure the resin does not cure prematurely. Prepreg fabrics can be more convenient to work with than non-prepreg fabrics, but can also be more costly. A composite structure, such as ballistic resistant vehicle door 500 constructed from prepreg carbon fiber fabric, often requires an oven or autoclave to fully cure (i.e. polymerize) the resin such that the composite structure takes on desirable structural attributes as the resin hardens. A variety of suitable process temperatures and durations for curing the resin are described herein.

In some examples, the resin used in the composite material can be a thermosetting resin, such as an epoxy resin, vinyl-ester resin, polyester resin, or other suitable resin. Resin selection can be based, at least in part, on fabric compatibility and the intended application and characteristics of the structural member (e.g. 510, 520). In many instances, epoxy resins are desirable for use in composite parts, since they create strong, light composite parts that are dimensionally stable. A suitable epoxy resin is System 2000 Epoxy Resin (Item No. 2000-A) available from Fibre Glast Developments Corporation.

The System 2000 Epoxy Resin can be mixed with a suitable epoxy hardener, such as 2020 Epoxy Hardener (Item No. 2020-A), 2060 Epoxy Hardener (Item No. 2060-A), or 2120 Epoxy Hardener (Item No. 2120-A) from Fibre Glast Developments Corporation. Selection of an epoxy hardener can be based, at least in part, on desired pot life and working time, which may be dictated by the size and complexity of the part being produced. For instance, where a part is larger and more complex, longer working times may be needed to ensure necessary fabrication steps can be completed before the resin cures. Epoxy hardener selection can also be based on desired cure temperature and cure time. A variety of suitable manufacturing temperatures and times are described herein for manufacturing ballistic resistant vehicle doors 500. An epoxy hardener should be selected that is compatible with the chosen manufacturing temperature and time. The post-cured service temperature of the final part should also be considered when selecting an epoxy hardener. Specifically, the craftsman should consider where the part will be used and what temperatures will be encountered in that environment. Certain epoxy hardeners, such as 2120 Epoxy Hardener, have service temperatures of over 200 degrees Fahrenheit, which can be desirable for high temperature applications, such as for structural ballistic resistant structures that will be used as firewalls or engine shrouds in a vehicle (100, 200).

A composite material containing carbon fiber fabric and epoxy is an example of an excellent structural member due to its high tensile strength, high compressive strength, high flexural strength, and excellent heat resistance and machinability. The structural member (e.g. 510, 520) can be formed by any suitable process, such as a wet layup process where liquid resin is distributed over a fabric made of carbon or glass fibers to wet out the fabric. The liquid resin can be distributed by hand, by a resin infusion process, or by any other suitable process. The wet layup process can utilize a peel ply layer or mold release agent to prevent the composite structural layer from adhering to a vacuum bagging film during a vacuum bagging process. An example of a suitable peel ply layer is Peel Ply Release Fabric (Catalog No. VB-P56150) available from U.S. Composites, Inc. of West Palm Beach, Fla.

During the layup process, carbon fiber fabric or glass fiber fabric can be trimmed to an appropriate size and then laid down over a mold (see, e.g. 400 in FIG. 4) or over a stack of ballistic sheets (e.g. 515, 540). Resin can then be applied to the surface of the carbon or glass fiber fabric using any suitable tool, such as a roller or brush. Through the lamination process, the resin is forced into the fabric to impregnate the fabric with resin. When prepreg carbon fiber fabrics are used in the layup, the step of applying resin can be omitted, since the fabric already contains a suitable amount of resin to facilitate the lamination process. A peel ply layer can be inserted between the prepreg carbon fiber fabric and the vacuum bagging film 410 to prevent the structural layer from adhering to the vacuum bagging film.

To encourage the one or more structural members to adhere to the stack of ballistic sheets, it may be necessary to insert a resin or film adhesive layer between the stack and the structural member. The resin or film adhesive can be an epoxy, epoxy foam, liquid resin, or any suitable film adhesive available from Collano AG, located in Germany. In one example, the structural ballistic resistant vehicle door 500 can include a first film adhesive layer between a first structural member (e.g. 520) and a top surface of a stack of ballistic sheets (e.g. 515). The first film adhesive layer can adhere the first structural member (e.g. 520) to the top surface of the stack of ballistic sheets (e.g. 515). The structural ballistic resistant vehicle door 500 can also include a second adhesive film layer between a second structural member (e.g. 510) and the bottom surface of the stack of ballistic sheets (e.g. 515). The second film adhesive layer can adhere the second structural member (e.g. 510) to the bottom surface of the stack of ballistic sheets (e.g. 515).

It can be desirable to manufacture a ballistic resistant door 500 that can replace an original vehicle door 300. To ensure ease of installation of the ballistic resistant door 500, the door should have identical or similar dimensions as the original door 300 it will replace. A process for manufacturing the ballistic resistant vehicle door 500 can make use of the original vehicle door 300 to create dimensionally stable molds for the interior and exterior surfaces of the ballistic resistant door. For instance, a mold 400 of the exterior surface 301 of the original door 300 can be created by applying a spreadable mold material onto the exterior surface of the original vehicle door. The spreadable mold material can be applied with any suitable process, such as by hand via a technique known as splash molding or through an automated process where the spreadable mold material is dispensed from a spray nozzle controlled by an individual or an automated system, such as an automated robot manufactured by ABB Ltd. of Switzerland. In one example, the mold material can be the mold material described in U.S. Pat. No. 7,767,014 to Strauss, which is hereby incorporated by reference in its entirety. The spreadable mold material can have a consistency similar to plaster. The spreadable mold material can have a viscosity that is low enough to permit it to be spread freely onto a surface and can have a viscosity that is high enough to prevent the mold material from running off of uneven surfaces due to gravity.

A mold release agent can be applied to the exterior surface 301 of the original vehicle door 300 prior to applying the mold material to ensure the original door can be separated from the mold 400 after the mold material has cured without damaging the mold or the original door. The mold release agent can be any suitable material, and, in certain examples, can contain wax, oil, polyvinyl alcohol (PVA), combination thereof, or any other chemical that prevents the door from bonding to the mold. In some examples, the exterior surface of the door 300 can be coated with a suitable wax and a PVA release film can be applied over the waxed surface. For instance, the exterior surface 301 of the door 300 can be coated with a suitable parting wax, such as PARTALL Paste #2 from REXCO of Conyers, Ga. to aid in release of the door from the mold. To ensure that no portion of the exterior surface of the door is free of wax, two or more coats of wax may be applied to the door. To further aid in the release of the door from the mold, a PVA release film, such as PVA Release Film (Item No. 13-A) from Fiber Glast Developments Corporation, can be applied over the layer of parting wax. In addition to making a mold 400 of the exterior surface 301 of the original door 300, a dimensionally stable mold of the interior surface 302 of the original vehicle door 300 can also be made. The process for making the mold 400 of the interior surface 301 of the original vehicle door 300 can follow similar steps as described above for making the mold 400 of the exterior surface 302 of the original vehicle door 300.

As shown in FIG. 3B, the original door 300 can include a trim panel 305 attached to an interior surface 302 of the door. The trim panel 305 can have both functional and aesthetic attributes. For instance, the trim panel 305 can include controls 315 for power windows and power door locks, and the trim panel can also include one or more fabric, plastic, leather, or vinyl trim portions 310 that enhance the appearance of the door by concealing the structural portions of the door. The trim panel 305 can also include a door handle 320 and armrest mounted to or integrated into the trim panel. To produce a mold 400 of the interior surface 302 of the original door 300, the trim panel 305 can be removed from the door, as shown in FIG. 3C. Once the trim panel 305 has been removed, components within the door 300 may need to be removed or relocated to permit the spreadable mold material to be applied directly onto the interior surface 302 of the door 300 without damaging components within the door 300. For example, a plastic dust cover may need to be removed and a door handle linkage and wiring harness may need to be temporarily removed or relocated before the mold material is applied to the interior surface 302 of the door 300. Once components have been removed or relocated and the interior surface 302 of the door 300 is fully exposed, the spreadable mold material can be applied to the interior surface 302 to form a layer of spreadable mold material that, upon curing, forms a hardened and structurally stable mold 400 of the interior surface 302 of the door 300. During this process, it is desirable to avoid damaging any components that remain within the door 300, since the components and trim panel 305 can be reused on a ballistic resistant vehicle door 500 to produce a fully functioning ballistic resistant door 500 that, for example, replaces the original door 300 of the commercially-available vehicle 200, and after being painted and clear-coated, looks nearly identical to the original door 300.

FIG. 4 shows a mold 400 of an interior surface of the original door 300 after the mold material has cured and the mold 400 has been separated from the original door 300. To improve the surface quality of a surface of the structural ballistic resistant vehicle door 500 (e.g. a carbon fiber composite surface of the structural ballistic resistant vehicle door) manufactured using the mold, it is desirable to reduce the surface roughness of the mold 400. This can be accomplished through one or more steps. First, the surface of the mold 400 can be sanded to remove peaks in the roughness profile of the mold, thereby decreasing the Rₐ value of the mold surface. In some instances, it can be desirable to sand the surface 405 of the mold 400 by hand with relatively light pressure to avoid removing too much mold material, which would alter the dimensions of the mold and thereby alter the dimensions of any part manufactured from the mold. After the surface 405 of the mold 400 has been sanded, the surface can be treated with, for example, a surface primer. The type of surface primer can be selected based, at least in part, on a process temperature that will be used to manufacture a part in the mold 400. Suitable surface primers for low temperature applications can be made of polyesters, suitable surface primers for medium temperature applications can be made of vinyl-esters, and suitable surface primers for high temperature applications can be made of epoxies. In one example, the surface primer can be a polyester-based surface primer such as Duratec Polyester Surfacing Primer manufactured by Hawkeye Industries Inc., which is located in Bloomington, Calif.

The surface primer can provide a better surface quality for manufacturing composite parts than the underlying mold material, since the surface primer has a low porosity and is therefore less prone to absorb liquid resins commonly used when manufacturing composite parts. The surface primer can be sanded with ultrafine sandpaper to further improve its surface quality.

As an optional step, after the surface of the mold 405 has been sanded and before the surface primer has been applied, an automotive style body filler or putty can be applied to the mold surface 405 to fill any imperfections or pin holes. Once the putty cures, it can be sanded to improve its surface quality, and then the surface primer can be applied and sanded.

Although certain molding processes are described herein where a mold material is applied directly to an original vehicle door 300 to produce dimensionally stable molds for the production of ballistic resistant vehicle doors 500, these processes are not limiting. In other examples, molds can be produced through any other suitable processes. For instance, molds can be machined from any dimensionally stable material, including metal (e.g. steel or aluminum), polymer, suitable organic matter (e.g. wood, bamboo, etc.), or castable mold material as described in U.S. Pat. No. 7,767,014 to Strauss. Alternately, the molds can be formed by 3D printing or any suitable additive manufacturing technology, such as selective laser sintering (SLS) of metal or polymer powders or stereolithography (SLA).

The mold 400 shown in FIG. 4 may be suitable for a small production run of parts. However, over time, the mold 400 made may experience degradation in the form of chipping or cracking of the mold surface 405. When the level of degradation surpasses a predefined threshold, the mold 400 may no longer be suitable for manufacturing saleable parts. At that point, the mold 400 will need to be replaced. In situations where large production runs will be performed, it may not be cost-effective to periodically produce new molds 400 whenever an existing mold wears out and must be replaced. To avoid this scenario, the mold 400 can be used to create a more durable long-term mold that is capable of producing a large number of parts before degradation occurs. The long-term mold may also be serviceable. For instance, when a crack or surface defect arises, the crack or surface defect can be repaired, and the long-term mold can be restored to a useable condition for a relatively low cost, thereby allowing production to resume. In one example, a master mold can be manufactured from a carbon fiber composite material or a fiberglass composite material formed against the mold surface 405 of the mold 400 using a vacuum bagging technique as described herein. In this example, the master mold 400 can be preserved (e.g. in storage) and can be used to manufacture subsequent molds 400 made of hardened, spreadable mold material whenever the long-term has reached the end of its useful life and can no longer be repaired.

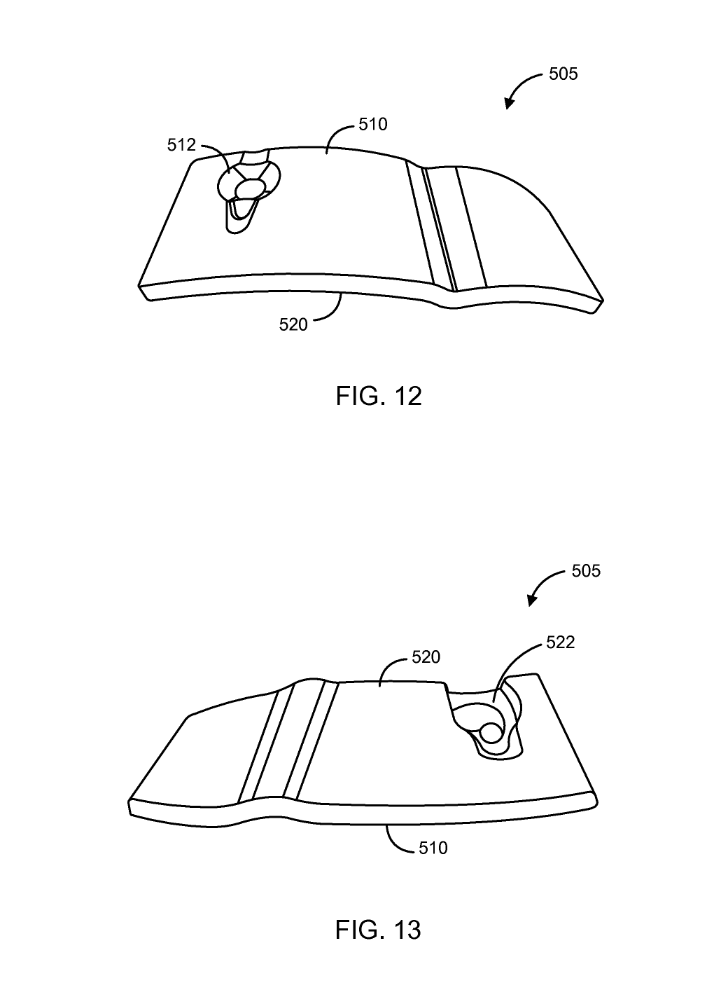

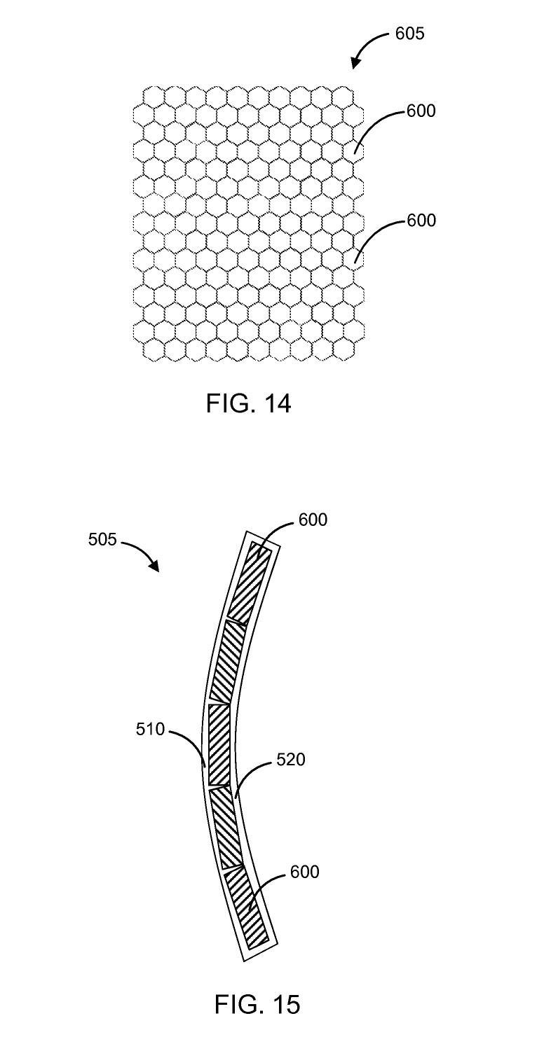

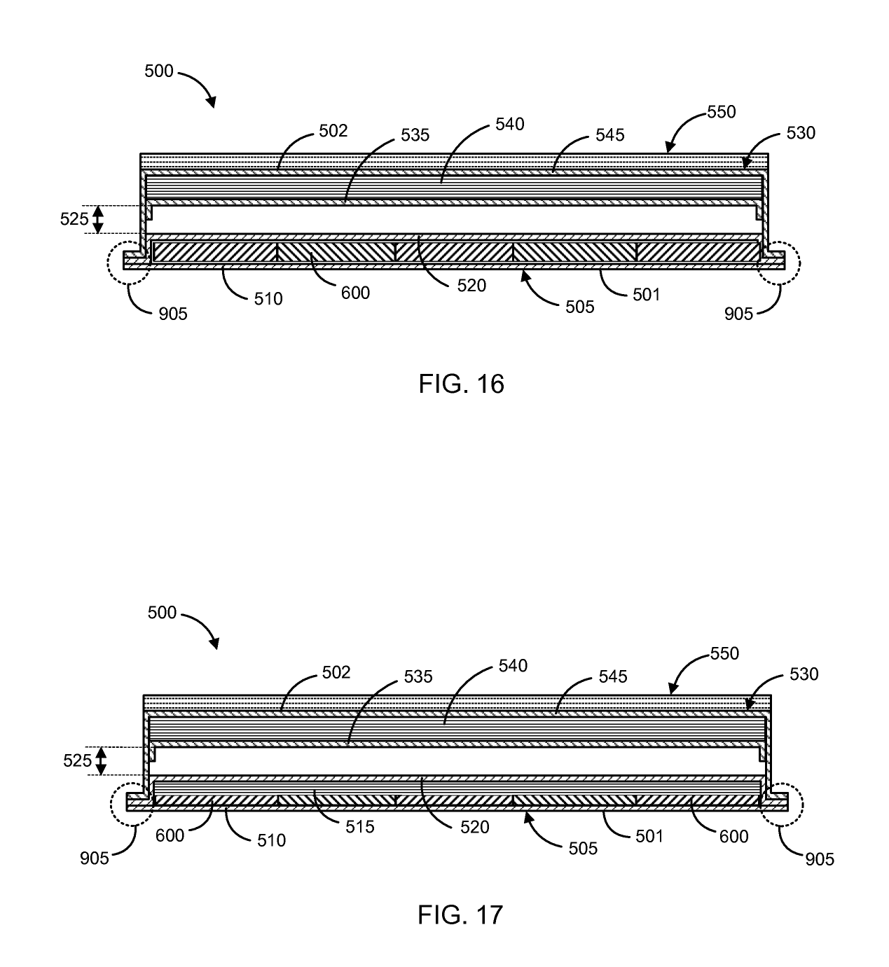

Although the figures in this application show specific details relating to making a ballistic resistant door 500 for a vehicle (e.g. FIGS. 1, 2, and 5-13), this is not limiting. The processes described herein can also be successfully applied to forming a body panel (e.g. hood, roof, trunk, quarter panel, etc.), fuel tank, skid plate, chassis, tailgate, cab, radiator shroud, or engine shroud for a vehicle (e.g. 100, 200). The processes described herein can also extend beyond vehicles and can be used in building materials and products for homes, offices, and businesses where ballistic protection is needed.

Once a mold 400 of the interior surface 302 of the original door 300 has been created, an inner door structure 530 can be manufactured using the mold. Likewise, once a mold of the exterior surface 301 of the original door 300 has been created, an outer door structure 505 can be manufactured using the mold. Portions of the inner and outer door structures (530, 505) can be made, at least in part, of carbon fiber composite materials. FIG. 9B shows an exploded cross-sectional view of a ballistic resistant door 500 having an inner door structure 530, an outer door structure 505, and a trim panel 550. FIG. 9A shows an assembled view of the same door 500 that is shown in FIG. 9B. The inner door structure 530 can include a stack of ballistic sheets 540 encased between a first structural portion 535 and a second structural portion 545. Similarly, the outer door structure 505 can include a stack of ballistic sheets 515 encased between a first structural portion 510 and a second structural portion 520. In some examples, the inner door structure 530 can be formed through a heated vacuum-bagging process using a mold 400 of the interior surface 302 of the door 300 to provide a contoured shape for the inner door structure 530 that matches the interior surface 302 of the original vehicle door 300. Likewise, the outer door structure 505 can be formed through a heated vacuum-bagging process using a mold 400 of the exterior surface 301 of the door 300 to provide a contoured shape for the outer door structure 505 that matches the exterior surface 301 of the original vehicle door 300.

As shown in FIGS. 9A and 9B, the inner door structure 530 can be joined to the outer door structure 505 along, for example, a perimeter region 905 of each door structure (505, 530) to form a ballistic resistant vehicle door 500. Joining of the inner and outer door structures (505, 530) can be provided by a continuous or discontinuous mating surface extending along the perimeter region 905 of the inner and outer door structures. In some examples, a film adhesive can be provided between a mating surface 531 of the inner door structure 530 and a mating surface 506 of the outer door structure 505 to facilitate joining of the inner door structure to the inner door structure. The film adhesive layer can be any suitable adhesive layer, such as a thermoplastic polymer, that serves to adhere the mating surface 531 of the inner door structure 530 with the mating surface 506 of the outer door structure 505. Heating of the adhesive layer may be required to facilitate joining of the inner door structure 530 to the outer door structure 505.

The ballistic resistant vehicle door 500 shown in FIGS. 9A and 9B contains two stacks of ballistic sheets (515, 540). In some examples, the ballistic resistant vehicle door 500 can include one stack of ballistic sheets, as shown in FIGS. 10 and 11, and in other examples, the door can include more than two stacks of ballistic sheets. The relative placement of one or more stacks of ballistic sheets within the vehicle door 500 can vary. In one example shown in FIG. 10, the stack of ballistic sheets 515 can be positioned within the outer door structure 505. In another example shown in FIG. 11, the stack of ballistic sheets 540 can be positioned within the inner door structure 530. Where two stacks (e.g. 515, 540) of ballistic sheets are included in the door 500, the stacks can be arranged in a spaced apart relation to enhance ballistic performance of the structural ballistic resistant vehicle door 500. For instance, the stacks of ballistic sheets can be arranged a distance 525 apart, as shown in FIG. 10. In a structural ballistic resistant vehicle door 500 for a commercial vehicle 200, the distance 525 can be about 0.5-3, 2-6, 5-10, or 8-12 inches. The distance 525 can be a suitable distance to provide a gap into which the window glass can retract when the window is rolled down, thereby providing enhanced ballistic performance while maintaining functionality comparable to the original vehicle door 300.

Where it is desirable for the ballistic resistant door 500 to have a feel and sound that is similar to the original door 300 when someone touches or raps on the exterior surface of the door, the first structural portion 510 can be made of, for example, sheet metal. This configuration can permit the ballistic resistant vehicle door to pass undetected when inspected at, for example, a checkpoint or border crossing.

To allow the original trim panel 305 and door components to be reattached to the door, it may be necessary to create openings and holes in the interior surface 502 of the ballistic resistant vehicle door 500 that match those on the original door 300. For example, as shown in FIG. 6, openings and holes must be created in the interior surface 502 of the ballistic resistant vehicle door 500. To simplify the process of creating the holes and openings in the interior surface 502 of the door 500, a template can be used. In one example, the template can be created by forming a composite material (e.g. fiberglass or carbon fiber composite material) over the interior surface 302 of the original door 300 shown in FIG. 3C. Once the template cures and hardens, the user can mark (e.g. with a marker or paint pen) all openings and holes directly on the template that correspond to the holes and openings in the original door. It is preferable to use fiberglass for the template material since it is transparent or translucent and allows a worker to easily see the openings and holes in the original door through the template.

### Ballistic Resistant Vehicle Door as a Structural Component

Existing ballistic resistant panels for vehicle doors 300 are designed to be hard mounted within a door cavity or draped over the side of the door adjacent to a trim panel 305. Unfortunately, these relatively crude panels are incapable of serving as structural members of the vehicle 200, since they are too weak to withstand significant compressive forces along multiple axes (e.g. x, y and z axes). Consequently, these panels do not improve the structural integrity of the vehicle and simply add weight to the existing door 300. Moreover, the ballistic performance of existing ballistic resistant panels for vehicle doors 500 is insufficient to protect against ballistic threats categorized above level IIIA.

When developing vehicle components that are resistant to ballistic threats, it can be desirable to produce components (e.g. doors 500) that also serve as structural supports for the vehicle. Ballistic resistant doors 500 that incorporate one or more structural support members (e.g. 510, 520, 535, 545) can significantly reduce the weight of a vehicle 200, by allowing heavier original components (e.g. steel door structures) to be eliminated and replaced with lighter ballistic resistant components (e.g. made of resin-infused carbon fiber fabric), which can reduce the vehicle's fuel consumption and can improve the vehicle's range.

It is desirable to produce a ballistic resistant vehicle door 500 that incorporates one or more structural members (e.g. 510, 520, 535, 545). The structural members can be made out of any suitable material or materials that increase the load-bearing capabilities of the ballistic resistant vehicle door (e.g. when the door is exposed to compressive or tensile forces). The material used to form the one or more structural members (e.g. 510, 520, 535, 545) of the door 500 can vary depending on the intended application of the door. For instance, where the purpose of the structural member is to bolster the stiffness of the ballistic resistant door 500 and improve the door's ability to withstand torsional or tensile forces without experiencing deflection or elongation, the one or more structural members (e.g. 510, 520, 535, 545) may be made of a carbon fiber composite material or a fiberglass composite material (e.g. a composite material containing S-glass fibers). In another example, where the purpose of the one or more structural members (e.g. 510, 520, 535, 545) is to bolster the stiffness of the ballistic resistant door 500 and enhance ballistic performance of the door, the structural members may be made of a metal or may incorporate a ceramic material in the form of one or more ceramic members. Suitable metals that can enhance the ballistic performance of the door include, for example, aluminum, steel, titanium, and magnesium. Suitable ceramics that can enhance the ballistic performance of the door include silicon carbide, boron carbide, titanium carbide, tungsten carbide, zirconia toughened alumina, and high-density aluminum oxide. Suitable ceramic materials that can enhance ballistic performance are commercially available from CoorsTek, Inc., located in Golden, Colo. and are sold under the trademarks CERASHIELD and CERCOM. Other suitable ceramic materials are commercially available from CeramTec GmbH, located in Germany. In some examples, the ceramic members can be a plurality of ceramic tiles arranged in a

Prior to placing the stack of ballistic sheets into the vacuum bag, a composite material can be placed on one or more outer surfaces of the stack to provide an inner and/or outer door structure (530, 505). In one example, the composite material (510, 520) can entirely surround the stack 515 of ballistic sheets, as shown in FIG. 9B, to form an exterior layer that encases the stack of ballistic sheets. In another example, the composite material (e.g. 510, 520) may be placed on a top surface and a bottom surface of the stack (e.g. 515) of ballistic sheets. In yet another example, the composite material can be placed on a top surface, bottom surface, or end surface of the stack. Through a vacuum bagging process, the composite material can be transformed into a structural member that is adapted to serve as a load-bearing member. For instance, the structural member can be adapted to endure compressive or tensile forces without significant deflection, elongation, or compression. The structural member can effectively protect the edges of the stack of ballistic sheets from becoming damaged during, for example, transport, installation, or use. It is desirable to protect the edges of the stack of ballistic sheets, since damage to an edge of the stack (e.g. 515) can decrease ballistic performance of the door structure (e.g. 505). For instance, if an edge of the stack (e.g. 515) is exposed to a compressive force (e.g. if the stack is dropped onto a hard surface), the sheets in the stack may delaminate near the edge of the stack, thereby reducing the ballistic performance of the inner or outer door structure (530, 505).

The structural member (e.g. 510, 520, 535, 545) can be made of any suitable composite material such as, for example, carbon fiber composite or fiberglass composite material. A composite material containing carbon fiber and epoxy is an example of an excellent structural material due to the stiffness of carbon fiber and the high tensile strength and extremely low elongation exhibited by carbon fiber. The structural member can be formed by any suitable process, such as a wet layup process (e.g. hand layup or resin infusion) where liquid resin (e.g. amorphous thermoplastic such as epoxy) is distributed over a woven or nonwoven fabric made of carbon or glass fibers to wet out the fabric. The wet layup process can utilize a peel ply layer or mold release agent to prevent the composite structural layer from adhering to the vacuum bagging film during the vacuum bagging process.

### Vacuum Bagging

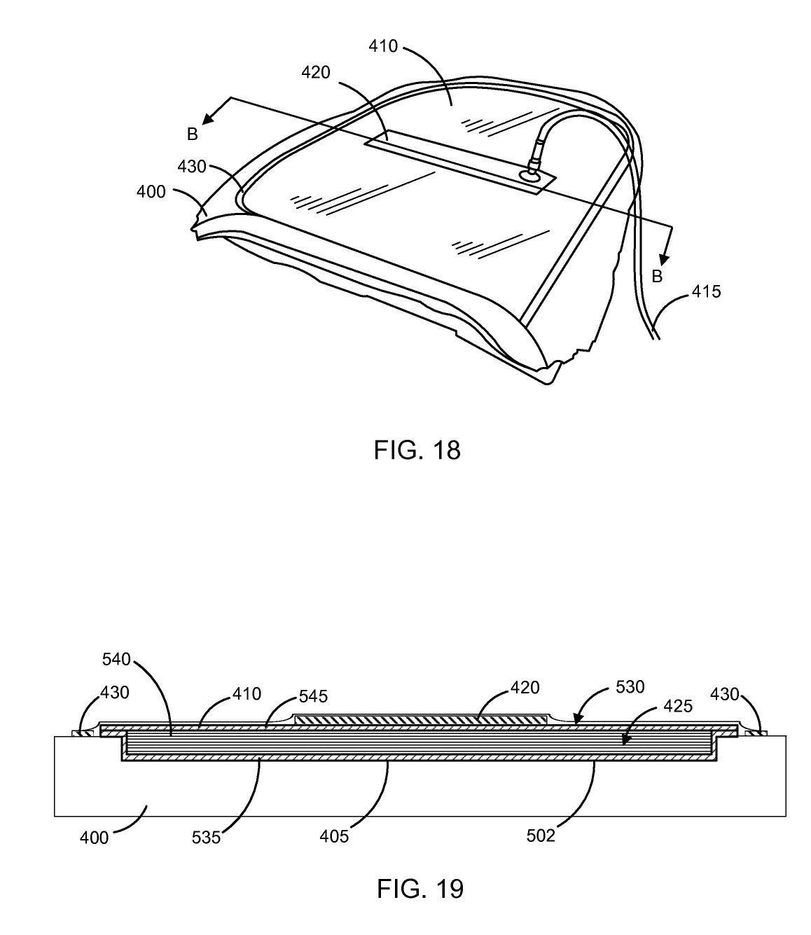

Portions of the ballistic resistant vehicle door 500, such as in the inner and outer door structures (530, 505) can be manufactured using a vacuum bagging process. For example, the inner door structure 530 shown in FIGS. 9A and 11 can be made through a vacuum bagging process that utilizes the mold 400 shown in FIG. 4 in a process shown in FIGS. 18 and 19. A vacuum bagging process can remove air present between adjacent ballistic sheets in a stack (e.g. 515, 540), thereby compressing the stack of ballistic sheets 540 and reducing its thickness.

During a manufacturing process, a mold release agent can be applied to the mold surface 405. Next, one or more layers of pre-impregnated carbon fiber composite material, which will become a structural member 535 upon curing, can be laid into the mold 400, as show in FIG. 19. A stack 540 of ballistic sheets can be placed on top of the one or more layers of pre-impregnated carbon fiber composite material. The stack 540 of ballistic sheets can include any suitable type of ballistic sheets, such as ballistic sheets made of aramid fiber or ballistic sheets made of UHMWPE fibers. One or more layers of pre-impregnated carbon fiber composite material can be laid on top of the stack 540 of ballistic sheets to encase the stack with carbon fiber composite material. A sheet of vacuum bagging film 410 can then be placed over the combination of ballistic sheets and layers of pre-impregnated carbon fiber composite materials. The perimeter of the sheet of vacuum bagging film 410 can then be sealed around the perimeter of the mold 400 using, for example, vacuum bag sealant tape 430, as shown in FIGS. 18 and 19.

The sheet of vacuum bag film 410 can be made from any suitable material, such as LEXAN, silicone rubber, TEFLON, fiberglass reinforced polyurethane, fiberglass reinforced polyester, or KEVLAR reinforced rubber. In one example, the sheet of vacuum bagging film 410 can be made from a transparent polymer material, such a Nylon Bagging Film available from U.S. Composites, Inc. of Florida. The sheet of vacuum bagging film 410 can be reusable, which can reduce consumables and decrease labor costs.

A vacuum hose 415 extending from a vacuum pump can be connected to a vacuum port located in the sheet of vacuum bagging film 410, as shown in FIG. 18. The vacuum pump can evacuate air from a sealed volume 425 located between an inner surface of the sheet of vacuum bagging film 410 and the mold surface 405, as shown in FIG. 19. A breather layer 420 can be positioned between the inner surface of the sheet of vacuum bagging film 410 and the topmost layer of pre-impregnated carbon fiber composite material to improve evacuation of air from the sealed volume 425, as shown in FIG. 19. The breather layer 420 can be made of an air-permeable material that provides an air pathway to encourage evacuation of air from the sealed volume 425. As air is evacuated from the sealed volume 425, the air pressure inside the sealed volume decreases. Meanwhile, ambient air pressure acting on the outer surface of the vacuum bagging film remains at atmospheric pressure (e.g. ˜14.7 psi). The pressure differential between the air pressure inside and outside of the sheet of the vacuum bagging film 410 is sufficient to produce a compressive force acting on the stack 540 of ballistic sheets and composite layers. The compressive force is applied uniformly over the stack 540 of ballistic sheets and composite layers, which can produce a door structure 530 with uniform or nearly uniform thickness if desired, and can improve surface finish quality on the exterior surface 502 of the door structure 530.

The differential established between the ambient air pressure acting on the outer surface of the sheet of vacuum bagging film 410 and the reduced air pressure acting on the inner surface of the sheet of vacuum bagging film can produce a stack (e.g. 515, 540) of ballistic sheets that is thinner than the stack was prior to the vacuum bagging process. In many applications, reducing the thickness of the stack (e.g. 515, 540), even if only by a small percentage (e.g. about 1-10%), is highly desirable. For instance, if implementation dictates that the stack (e.g. 515, 540) is constrained to a certain thickness (e.g. for use in a portion of a vehicle door), by vacuum bagging the stack, the thickness of the stack can be reduced, thereby permitting additional ballistic sheets to be incorporated into the stack, which can significantly improve the ballistic performance of the stack. In certain applications, such as in ballistic resistant doors 500 or panels for military vehicles (e.g. tanks or mine-resistant ambush protected (MRAP) vehicles), improving the ballistic performance of the door or panel, even if only incrementally, can be a life-saving improvement.

### Applying Heat

During formation of the structural ballistic resistant door 500, portions of the ballistic resistant vehicle door 500, such as in the inner and outer door structures (530, 505) can be manufactured using a heating process. In some examples, the entire mold 400, as shown in FIGS. 18 and 19, with vacuum bagging film 410 installed over the door structure materials, can be inserted in an autoclave and heated while a vacuum pump is used to evacuate air from the sealed volume 425 located between the inner surface of the vacuum bagging film 410 and the mold surface 405.

Heating can promote bonding (e.g. partial or full) between adjacent ballistic sheets in the stack (e.g. 515, 540). Full or partial bonding is desirable since it can enhance the door portion's (e.g. 530, 505) ability to dissipate impact energy of a projectile that strikes the door as the ballistic sheets within the door experience delamination. During delamination, adjacent ballistic sheets that were partially or fully bonded prior to impact are separated (i.e. delaminated) in response to the projectile entering the panel, and the energy required to separate those ballistic sheets is extracted from the projectile, thereby reducing the speed of the projectile and eventually stopping the projectile. A ballistic resistant vehicle door 500 containing ballistic sheets that are laminated together by a heating process can more effectively dissipate impact energy from a projectile than a panel that has no bonding and is simply a stack of ballistic sheets sewn together or held loosely by a cover or encasement.

In one example, heating the stack (e.g. 515, 540) of ballistic sheets can occur while the stack is being vacuum bagged. In another example, the stack (e.g. 515, 540) of ballistic sheets can be heated after vacuum bagging and after the stack has been removed from the vacuum bag. In yet another example, heating can occur before the stack (e.g. 515, 540) of ballistic sheets has been subjected to a vacuum bagging process. Heating can occur using any suitable heating equipment such as, for example, a conventional oven, infrared oven, hydroclave, or autoclave. During the heating process, a process temperature can be selected based, at least in part, on a melting point of one or more resins that are incorporated into one or more of the ballistic sheets in the stack (e.g. 515, 540). For instance, if the stack (e.g. 515, 540) includes a ballistic sheet containing a thermoplastic polymer resin with a melting temperature at about 248 degrees F., the process temperature can be increased to about 220 or about 220-250 degrees F. to promote softening or melting of the resin in the ballistic sheets to produce a laminated stack of ballistic sheets.

In some examples, the ballistic sheet material may have a melting point of about 266-277 degrees Fahrenheit. In some instances, it can be desirable to maintain a heating temperature below the melting point of the ballistic sheet material to avoid altering the ballistic properties of the material. In other instances, it can be desirable for the heating temperature to exceed the melting temperature to promote melting of the ballistic sheet material and to alter the ballistic properties of the material.

To promote partial or full bonding of adjacent ballistic sheets in the stack (e.g. 515, 540), the stack can be heated to a suitable temperature for a suitable duration. Suitable temperatures and durations may depend on the types of resin or resins present in the one or more ballistic sheets in the stack (e.g. 515, 540). Examples of suitable process temperatures and durations for a heating process for any of the various stacks of ballistic sheets described herein can include, for example: 125-550 degrees F. for at least 1 second; 125-550 degrees F. for at least 5 minutes; 125-550 degrees F. for at least 15 minutes; 125-550 degrees F. for at least 30 minutes; 125-550 degrees F. for at least 60 minutes; 125-550 degrees F. for at least 90 minutes; 125-550 degrees F. for at least 120 minutes; 125-550 degrees F. for at least 180 minutes; 125-550 degrees F. for at least 240 minutes; 125-550 degrees F. for at least 480 minutes; 225-350 degrees F. for at least 1 second; 225-350 degrees F. for at least 5 minutes; 225-350 degrees F. for at least 15 minutes; 225-350 degrees F. for at least 30 minutes; 225-350 degrees F. for at least 60 minutes; 225-350 degrees F. for at least 90 minutes; 225-350 degrees F. for at least 120 minutes; 225-350 degrees F. for at least 180 minutes; 225-350 degrees F. for at least 240 minutes; 250-350 degrees F. for at least 1 second; 250-350 degrees F. for at least 5 minutes; 250-350 degrees F. for at least 15 minutes; 250-350 degrees F. for at least 30 minutes; 250-350 degrees F. for at least 60 minutes; 250-350 degrees F. for at least 90 minutes; 250-350 degrees F. for at least 120 minutes; 250-350 degrees F. for at least 180 minutes; 250-350 degrees F. for at least 240 minutes; 250-300 degrees F. for at least 1 second; 250-300 degrees F. for at least 5 minutes; 250-300 degrees F. for at least 15 minutes; 250-350 degrees F. for at least 30 minutes; 250-300 degrees F. for at least 60 minutes; 250-350 degrees F. for at least 90 minutes; 250-300 degrees F. for at least 120 minutes; 250-300 degrees F. for at least 180 minutes; 250-300 degrees F. for at least 240 minutes; 225-275 degrees F. for at least 1 second; 225-275 degrees F. for at least 5 minutes; 225-275 degrees F. for at least 15 minutes; 225-275 degrees F. for at least 30 minutes; 225-275 degrees F. for at least 60 minutes; 225-275 degrees F. for at least 90 minutes; 225-275 degrees F. for at least 120 minutes; 225-275 degrees F. for at least 180 minutes; 225-275 degrees F. for at least 240 minutes; 225-250 degrees F. for at least 1 second; 225-250 degrees F. for at least 5 minutes; 225-250 degrees F. for at least 15 minutes; 225-250 degrees F. for at least 30 minutes; 225-250 degrees F. for at least 60 minutes; 225-250 degrees F. for at least 90 minutes; 225-250 degrees F. for at least 120 minutes; 225-250 degrees F. for at least 180 minutes; 225-250 degrees F. for at least 240 minutes; 240-260 degrees F. for at least 1 second; 240-260 degrees F. for at least 5 minutes; 240-260 degrees F. for at least 15 minutes; 240-260 degrees F. for at least 30 minutes; 240-260 degrees F. for at least 60 minutes; 240-260 degrees F. for at least 90 minutes; 240-260 degrees F. for at least 120 minutes; 240-260 degrees F. for at least 180 minutes; 240-260 degrees F. for at least 240 minutes; 140-225 degrees F. for at least 1 second; 140-225 degrees F. for at least 5 minutes; 140-225 degrees F. for at least 15 minutes; 140-225 degrees F. for at least 30 minutes; 140-225 degrees F. for at least 60 minutes; 140-225 degrees F. for at least 90 minutes; 140-225 degrees F. for at least 120 minutes; 140-225 degrees F. for at least 180 minutes; or 140-225 degrees F. for at least 240 minutes. For any of the above-mentioned process temperatures and durations for a heating process, the stack (e.g. 515, 540) of ballistic sheets may be sealed within a vacuum bag during the heating process. In certain examples, a vacuum hose 415 extending from a vacuum pump can remain connected to a vacuum port on the vacuum bag 410 during the heating process. This configuration may ensure good results even if the vacuum bag 410 is not perfectly sealed against the mold 400.

Exposing the door portion (e.g. 505, 530) to a higher temperature during the heating process can effectively reduce cycle times, which can be desirable for mass production. Due to the thickness and heat transfer properties of the door portion (e.g. 505, 530), exposing the door portion to a high temperature (e.g. 550 degrees F.) for a relatively short duration may allow the inner portion of the panel to achieve a target temperature needed for bonding (e.g. 240-275 degrees F.) more quickly than if the heat source was initially set to a lower value closer to the target temperature needed for bonding.

### Applying Pressure

During formation of the inner and outer door structures (e.g. 530, 505) of the ballistic resistant vehicle door 500, pressure can be applied to the inner and outer door structures. Appling pressure to the inner and outer door structures can significantly improve the ballistic performance of the inner and outer door structures. Applying pressure to the inner and outer door structures can also reduce the thickness of the stacks of ballistic sheets (e.g. by 5 percent or more), which can leave more space for door components, such as window and door lock mechanisms and window glass, that must be installed between the inner and outer door structures. Pressure can promote partial or full bonding of adjacent ballistic sheets in the stack (e.g. 540, 515) located in the inner and outer door structures to form a partially or fully laminated stack of ballistic sheets. Pressure can be applied to the inner and outer door structures (e.g. 530, 505) using a mechanical press, autoclave, hydroclave, bladder press, or other suitable device. In one example, pressure can be applied to the stack (e.g. 540, 515) during the heating process. In another example, pressure can be applied to the stack (e.g. 540, 515) of ballistic sheets before the heating process. In yet another example, pressure can be applied to the stack (e.g. 540, 515) of ballistic sheets after the heating process. In still another example, pressure may not be applied to the stack of ballistic sheets aside from the relatively modest pressure applied through the vacuum bagging process. If pressure is applied to the stack (e.g. 540, 515) of ballistic sheets, it can occur after the stack of ballistic sheets has been vacuum bagged and while the stack is still in the vacuum bag and being heated. Alternately, pressure can be applied to the stack (e.g. 540, 515) of ballistic sheets after the stack has been removed from the vacuum bag or before the stack is inserted into the vacuum bag.

During a process involving both heat and pressure, a process temperature can be selected based on a melting point of a resin (e.g. a layer of resin on one side of each ballistic sheet) present on the one or more of the ballistic sheets in the stack (e.g. 540, 515). For instance, if the stack (e.g. 540, 515) includes a ballistic sheet containing a first resin with a melting temperature near 250 degrees F., the process temperature can be increased to about 230-255 degrees F. to promote softening or melting of the first resin in the ballistic sheet.

To promote lamination (e.g. partial or full bonding) of adjacent ballistic sheets in the stack (e.g. 540, 515), a suitable pressure can be applied to the stack for a suitable duration or, where appropriate, momentarily. Suitable pressures and durations may depend on the type of resin present in the one or more ballistic sheets in the stack (e.g. 540, 515). Examples of suitable process pressures and durations for any of the various stacks of ballistic sheets described herein can include, for example: 10-100 psi for at least 1 second, 10-100 psi for at least 1 minute; 10-100 psi for at least 5 minutes; 10-100 psi for at least 15 minutes; 10-100 psi for at least 30 minutes; 10-100 psi for at least 60 minutes; 10-100 psi for at least 90 minutes; 10-100 psi for at least 120 minutes; 10-100 psi for at least 180 minutes; 10-100 psi for at least 240 minutes; 50-75 psi for at least 1 second; 50-75 psi for at least 5 minutes; 50-75 psi for at least 15 minutes; 50-75 psi for at least 30 minutes; 50-75 psi for at least 60 minutes; 50-75 psi for at least 90 minutes; 50-75 psi for at least 120 minutes; 50-75 psi for at least 180 minutes; 50-75 psi for at least 240 minutes; 50-100 psi for at least 1 second; 50-100 psi for at least 5 minutes; 50-100 psi for at least 15 minutes; 50-100 psi for at least 30 minutes; 50-100 psi for at least 60 minutes; 50-100 psi for at least 90 minutes; 50-100 psi for at least 120 minutes; 50-100 psi for at least 180 minutes; 50-100 psi for at least 240 minutes; at least 10 psi for at least 1 second; at least 10 psi for at least 5 minutes; at least 10 psi for at least 15 minutes; at least 10 psi for at least 30 minutes; at least 10 psi for at least 60 minutes; at least 10 psi for at least 90 minutes; at least 100 psi for at least 120 minutes; at least 10 psi for at least 180 minutes; at least 10 psi for at least 240 minutes; at least 100 psi for at least 1 second; at least 100 psi for at least 5 minutes; at least 100 psi for at least 15 minutes; at least 100 psi for at least 30 minutes; at least 100 psi for at least 60 minutes; at least 100 psi for at least 90 minutes; at least 100 psi for at least 120 minutes; at least 100 psi for at least 180 minutes; or at least 100 psi for at least 240 minutes.

Lower pressures may be achievable with, for example, a manual press or a small autoclave. In other examples, higher pressures can be applied to the stack of ballistic sheets with, for example, an industrial autoclave, hydroclave, bladder press (e.g. made of KEVLAR reinforced rubber), a pneumatic press, or a hydraulic press. To promote lamination (e.g. partial or full bonding) of adjacent ballistic sheets in the stack (e.g. 540, 515), a suitable pressure can be applied to the stack for a suitable duration or momentarily. Suitable pressures and durations may depend on the types of resin present in the one or more ballistic sheets in the stack (e.g. 540, 515). Examples of suitable process pressures and durations for any of the various stacks of ballistic sheets described herein can include, for example: at least 500 psi for at least 1 second; at least 500 psi for at least 5 minutes; at least 500 psi for at least 15 minutes; at least 500 psi for at least 30 minutes; at least 500 psi for at least 60 minutes; at least 500 psi for at least 90 minutes; at least 500 psi for at least 120 minutes; at least 500 psi for at least 180 minutes; at least 500 psi for at least 240 minutes; at least 1,000 psi for at least 1 second; at least 1,000 psi for at least 5 minutes; at least 1,000 psi for at least 15 minutes; at least 1,000 psi for at least 30 minutes; at least 1,000 psi for at least 60 minutes; at least 1,000 psi for at least 90 minutes; at least 1,000 psi for at least 120 minutes; at least 1,000 psi for at least 180 minutes; or at least 1,000 psi for at least 240 minutes; at least 2,500 psi for at least 1 second; at least 2,500 psi for at least 5 minutes; at least 2,500 psi for at least 15 minutes; at least 2,500 psi for at least 30 minutes; at least 2,500 psi for at least 60 minutes; at least 2,500 psi for at least 90 minutes; at least 2,500 psi for at least 120 minutes; at least 2,500 psi for at least 180 minutes; or at least 2,500 psi for at least 240 minutes.

Examples of other suitable process pressures and durations for any of the various stacks (e.g. 540, 515) of ballistic sheets described herein can include, for example: 40-90 psi for at least 1 second; 40-90 psi for at least 1 minute; 40-90 psi for at least 5 minutes; 40-90 psi for at least 15 minutes; 40-90 psi for at least 30 minutes; 40-90 psi for at least 60 minutes; 40-90 psi for at least 90 minutes; 40-90 psi for at least 120 minutes; 40-90 psi for at least 180 minutes; 40-90 psi for at least 240 minutes; 60-90 psi for at least 1 second; 60-90 psi for at least 1 minute; 60-90 psi for at least 5 minutes; 60-90 psi for at least 15 minutes; 60-90 psi for at least 30 minutes; 60-90 psi for at least 60 minutes; 60-90 psi for at least 90 minutes; 60-90 psi for at least 120 minutes; 60-90 psi for at least 180 minutes; 60-90 psi for at least 240 minutes; 90-150 psi for at least 1 second; 90-150 psi for at least 1 minute; 90-150 psi for at least 5 minutes; 90-150 psi for at least 15 minutes; 90-150 psi for at least 30 minutes; 90-150 psi for at least 60 minutes; 90-150 psi for at least 90 minutes; 90-150 psi for at least 120 minutes; 90-150 psi for at least 180 minutes; 90-150 psi for at least 240 minutes; 500-700 psi for at least 1 second; 500-700 psi for at least 1 minute; 500-700 psi for at least 5 minutes; 500-700 psi for at least 15 minutes; 500-700 psi for at least 30 minutes; 500-700 psi for at least 60 minutes; 500-700 psi for at least 90 minutes; 500-700 psi for at least 120 minutes; 500-700 psi for at least 180 minutes; 500-700 psi for at least 240 minutes; 1,100-1,300 psi for at least 1 second; 1,100-1,300 psi for at least 1 minute; 1,100-1,300 psi for at least 5 minutes; 1,100-1,300 psi for at least 15 minutes; 1,100-1,300 psi for at least 30 minutes; 1,100-1,300 psi for at least 60 minutes; 1,100-1,300 psi for at least 90 minutes; 1,100-1,300 psi for at least 120 minutes; 1,100-1,300 psi for at least 180 minutes; 1,100-1,300 psi for at least 240 minutes; 150-2,500 psi for at least 1 second; 150-2,500 psi for at least 1 minute; 150-2,500 psi for at least 5 minutes; 150-2,500 psi for at least 15 minutes; 150-2,500 psi for at least 30 minutes; 150-2,500 psi for at least 60 minutes; 150-2,500 psi for at least 90 minutes; 150-2,500 psi for at least 120 minutes; 150-2,500 psi for at least 180 minutes; or 150-2,500 psi for at least 240 minutes; 2,500-15,000 psi for at least 15 minutes; 2,500-15,000 psi for at least 30 minutes; 2,500-15,000 psi for at least 60 minutes; 2,500-15,000 psi for at least 90 minutes; 2,500-15,000 psi for at least 120 minutes; 2,500-15,000 psi for at least 180 minutes; 2,500-15,000 psi for at least 240 minutes; 15,000-30,000 psi for at least 15 minutes; 15,000-30,000 psi for at least 30 minutes; 15,000-30,000 psi for at least 60 minutes; 15,000-30,000 psi for at least 90 minutes; 15,000-30,000 psi for at least 120 minutes; 15,000-30,000 psi for at least 180 minutes; or 15,000-30,000 psi for at least 240 minutes.

### Applying Heat and Pressure

Heat and pressure can be applied simultaneously to reduce the overall cycle time required to manufacture the inner and outer door structures (530, 505) for a ballistic resistant vehicle door 500 and to improve ballistic performance of the door. An autoclave can facilitate these combined processes. An autoclave is a pressure vessel that can be used to apply elevated pressure and temperature to the inner and outer door structures (530, 505) during a process involving the application of both heat and pressure. If pressure is applied to the inner and outer door structures (530, 505) during the heating process, the process temperature can be modified to account for the effect pressure has on the melting point of the one or more resins that are incorporated into one or more of the ballistic sheets in the stack (e.g. 545, 515) within each door structure. For instance, if the melting point of the resin increases as pressure increases, the target process temperature required during the heating process can be increased when the heating process occurs in conjunction with the pressure process to ensure melting of the resin.

The entire mold 400, as shown in FIGS. 18 and 19, with vacuum bagging film 410 installed over the door structure materials (e.g. stack of ballistic sheets and carbon fiber composite layers), can be inserted into an autoclave and heated while a vacuum pump is used to evacuate air from the sealed volume 425 located between the inner surface of the vacuum bagging film 410 and the mold surface 405. The autoclave can be pressurized to apply additional compressive force urging the door structure materials (e.g. stack of ballistic sheets and carbon fiber composite layers) against the contour of the mold 400, thereby promoting bonding of adjacent ballistic sheets in the stack and promoting bonding between the structural layers and the stack. In some examples, a thermoplastic adhesive layer can be used on both sides of the stack to promote bonding to the structural layers. After the inner and outer door structures (530, 505) have been heated to a predetermined temperature for a predetermined duration in the mold 400, they can be cooled.

### 3-Dimensional Forming

The structural ballistic resistant door 500 can be a flat panel or can be formed into a three-dimensional shape through a suitable forming process. In one example, 3-D forming of the structural ballistic resistant vehicle door can occur during a heating process while the structure is being vacuum bagged. During the heating process, the door can be placed in a mold and a press, such as a hydraulic, pneumatic, or manual press, can apply pressure to a surface of the door to encourage the door to conform to the shape of the mold. In other examples, pressure may be applied to the door using an autoclave or hydroclave. In some instances, the panel may be permitted to cool in the mold 400 following the 3-D forming process to ensure that lamination of adjacent sheets is complete before the structure (505, 530) is removed from the mold 400.

Three-dimensional forming of a door structure (e.g. 505) can include arranging a stack (e.g. 515) of ballistic sheets encased by an exterior layer (e.g. a carbon fiber composite exterior layer 510, 520) into a contoured mold 400 and vacuum bagging the stack and exterior layer, as shown in FIGS. 18 and 19. The exterior layer can be a composite layer wrapped around the stack or can be two or more separate layers that, in combination, encase the stack 540 of ballistic sheets. The vacuum bagging process can exert a compressive force on the stack (e.g. 515) and the exterior layer (e.g. 510, 520) that is sufficient to press the ballistic sheets and exterior layer firmly against the mold surface 405, thereby causing the stack 540 and exterior layer to assume the geometry of the mold surface 405. In some examples, during the heating and vacuum bagging processes, pressure can be applied to the stack and exterior layer by an autoclave, hydroclave, or press, such as a hydraulic, pneumatic, or manual press, to further encourage the door structure 530 to conform to the shape of the mold. The door structure 530 can be permitted to cool in the mold 400 following the 3-D forming process to ensure that lamination of adjacent sheets in the stack 540 is complete before the door structure 530 is removed from the mold.

Although the examples above describe 3-D forming a door 500 (or a portion of a door) while the door is being heated and vacuum bagged or shortly after, in other examples 3-D forming can occur prior to vacuum bagging, prior to heating, or prior to both vacuum bagging and heating. In these examples, pressure can be applied to the stack 540 of ballistic sheets and the exterior layer using a suitable press (e.g. hydraulic, pneumatic, or manual), autoclave, or hydroclave. The pressure can encourage the stack 540 of ballistic sheets and the exterior layer to conform to the shape of the mold 400. The stack 540 of ballistic sheets and the exterior layer can then be vacuum bagged and heated to encourage the stack of ballistic sheets and the exterior layer to fully conform to the mold surface 405 to produce a suitable part.

### Ballistic Sheet Construction

The ballistic resistant vehicle doors 500 described herein can include one or more ballistic sheets. The term “sheet,” as used herein, can describe one or more layers containing any suitable material, such as a polymer, metal, fiberglass, ceramic, composite, or combination thereof. Examples of polymers include aramids, para-aramids, meta-aramids, polyolefins, and thermoplastic polyethylenes. Commercially-available examples of aramids, para-aramids, and meta-aramids are sold under the trademarks NOMEX, KERMEL, KEVLAR, TWARON, NEW STAR, TECHNORA, HERACRON, and TEIJINCONEX. An example of a polyolefin is sold under the trademark INNEGRA. Examples of thermoplastic polyethylenes include TENSYLON from E. I. du Pont de Nemours and Company, DYNEEMA from Dutch-based DSM, and SPECTRA from Honeywell International, Inc., which are all examples of ultra-high-molecular-weight polyethylenes (UHMWPE). Examples of glass fibers used in ballistic sheets made of fiberglass include A-glass (soda lime silicate glass), C-glass (e.g. calcium borosilicate glass), D-glass (e.g. borosilicate glass), E-glass (e.g. alumina-calcium-borosilicate glass), E-CR-glass (calcium aluminosilicate glass), R-glass (e.g. calcium aluminosilicate glass), S-glass, S-2 glass (e.g. magnesium aluminosilicate glass fibers having diameters ranging from about 5 to 24 μm), and T-glass. Other suitable fibers that can be used in ballistic sheets include M5 (polyhydroquinone-diimidazopyridine), which has high strength and is also fire-resistant.

A ballistic sheet can be constructed using any suitable manufacturing process, such as extruding, die cutting, forming, pressing, weaving, rolling, etc. In certain instances, the ballistic sheet can be manufactured accordingly to a proprietary or trade secreted method. The ballistic sheet can include a woven or non-woven construction of a plurality of fibers bonded by a resin, such as a thermoplastic polymer, thermoset polymer, elastic resin, or other suitable resin.

In some examples, the ballistic sheets can be pre-impregnated with a resin, such as thermoplastic or thermoset polymer including epoxy, phenolic, polyester, urethane, vinyl ester, polyethylene, and bismaleimide (BMI). The resin can be partially cured to allow for easy handling and storage of the ballistic sheet prior to formation of the ballistic resistant vehicle door 500. To prevent complete curing (e.g. polymerization) of the resin before the sheet is incorporated into the door 500, the ballistic sheet may require cold storage. In other examples, the ballistic sheet may or may not be pre-impregnated, and a sheet of film adhesive may be inserted between two adjacent ballistic sheets to promote bonding of the adjacent ballistic sheets by melting the film adhesive via a heating process. Suitable film adhesives are available from Collano AG.

In another example, the ballistic sheet can be made of ultra-high-molecular-weight polyethylene and can be formed by any suitable process, such as one of the processes described in U.S. Pat. No. 7,923,094 to Harding et al., U.S. Pat. No. 7,470,459 to Weedon et al., or U.S. Pat. No. 7,348,053 to Weedon et al., which are hereby incorporated by reference in their entirety. The resulting ballistic sheet can have ballistic properties that distinguish it from sheets made of aramid fibers.

### Commercially-Available Ballistic Sheets Made of UHWMPE

E. I. du Pont de Nemours and Company (DuPont), located in Delaware, manufactures a ballistic sheet material made of ultra-high-molecular-weight polyethylene that is sold under the trademark TENSYLON. In some examples, the UHMWPE ballistic sheets can be bidirectional pre-impregnated composite sheets. A Material Data Safety Sheet was prepared on Feb. 2, 2010 for a material sold under the tradename TENSYLON HTBD-09-A (Gen 2) by BAE Systems TENSYLON High Performance Materials. The Material Safety Data Sheet is identified as TENSYLON MSDS Number 1005 and is hereby incorporated by reference in its entirety. Ballistic sheets made of TENSYLON are lightweight and cost-effective and boast low back face deformation, excellent flexural modulus, and superior multi-threat capability over other commercially available ballistic sheets. The ballistic material can be purchased on a roll and can be cut into ballistic sheets having a size and shape dictated by an intended application.

Teijin Limited, headquartered in the Netherlands, manufactures a ballistic resistant sheet material made of ultra-high-molecular-weight polyethylene fabric in a solvent-free process. The sheet material is sold under the trademark ENDUMAX and is available with a thickness of about 55 micrometers.

### Commercially-Available Ballistic Sheets Made of Aramid Fibers

Ballistic sheets constructed from high performance fibers, such as aramid, para-aramids, or meta-aramids fibers, are commercially available from several manufacturers. Ballistic sheets are commercially available in various configurations, including uni-ply, 0/90 x-ply, and 0/90/0/90 double x-ply configurations. Ballistic sheeting material can be ordered in a wide variety of forms, including tapes, laminates, rolls, sheets, structural sandwich panels, and preformed inserts, which can all be cut to size during one or more manufacturing processes and incorporated into a ballistic resistant vehicle door 500 as described herein.

TechFiber, LLC, located in Arizona, manufactures a variety of ballistic sheets made of aramid fibers that are sold under the trademark K-FLEX. One version of K-FLEX is made with KEVLAR fibers with a denier of about 1000 and can have a pick count of about 18 picks/inch. K-FLEX can have a resin content of about 15-20%. Different versions of K-FLEX ballistic sheets may contain different resins. For instance, a first version of K-FLEX may contain a resin with a melting temperature of about 325 degrees F., a second version of K-FLEX may contain a resin with a melting temperature of about 266 degrees F., and a third version of K-FLEX may contain a resin with a melting temperature of about 250 degrees F. K-FLEX is available in uni-ply, 0/90 x-ply, and 0/90/0/90 double x-ply configurations.

TechFiber, LLC also manufactures a variety of ballistic sheets made of aramid fibers that are sold under the trademark T-FLEX. Different versions of T-FLEX ballistic sheets can contain different resins. A first version of T-FLEX can include a resin with a melting temperature of about 325 degrees F., a second version of T-FLEX can include a resin with a melting temperature of about 266 degrees F., and a third version of T-FLEX can include a resin with a melting temperature of about 250 degrees F. Certain versions of T-FLEX have a resin content of about 15-20% and include aramid fibers such as TWARON fibers (e.g. model number T765). T-FLEX is available in uni-ply, 0/90 x-ply, and 0/90/0/90 double x-ply configurations.

Polystrand, Inc., located in Colorado, manufactures a variety of ballistic sheets made of aramid fibers that are sold under the trademark THERMOBALLISTIC. One version of THERMOBALLISTIC ballistic sheets are sold as product number TBA-8510 and include KEVLAR fibers with a pick count of about 12.5 picks per inch. Different versions of THERMOBALLISTIC ballistic sheets can contain different resins. One version of THERMOBALLISTIC ballistic sheets can include a resin with a melting temperature of about 355 degrees F. One version of THERMOBALLISTIC ballistic sheets can include a polypropylene resin. The resin content of the THEMROBALLISTC ballistic sheets can be about 15-20%. THERMOBALLISTIC ballistic sheets are available in uni-ply, 0/90 x-ply, and 0/90/0/90 double x-ply configurations.

Honeywell International, Inc., headquartered in New Jersey, manufactures a variety of ballistic sheets made of aramid fibers that are sold under the trademark GOLD SHIELD. One version of GOLD SHIELD ballistic sheets is sold as product number GN-2117 and is available in 0/90 x-ply configurations and have an areal density of about 3.24 ounces per square yard.

Barrday, Inc., headquartered in Cambridge, Ontario, manufactures a variety of ballistic sheets made of para-aramid fibers that are sold under the trademark BARRFLEX. One version of BARRFLEX ballistic sheets is sold as product number U480 and is available in 0/90 x-ply configurations. Each layer of the ballistic sheet is individually constructed with a thermoplastic film laminated to a top and bottom surface.

Ply-Tech, Inc., located in New Braunfels, Tex. manufactures a variety of ballistic resistant sheets made of aramid fibers that are sold under the trademark KM2 1000. One version of KM2 1000 is made of 1,000 denier KEVLAR KM2 brand yarn from DuPont and is a biaxial (i.e. 0/90 X-ply) ballistic resistant sheet 250 with a fabric weight (i.e. areal density) of about 5.7 ounces per square yard. The KM2 1000 0/90 X-ply ballistic resistant sheet 250 can include two uni-ply ballistic resistant sheets (e.g. 50, 55) bonded together with an adhesive resin. Each uni-ply ballistic sheet (e.g. 50, 55) can include a plurality of KM2 brand fibers arranged unidirectionally to form a two-dimensional arrangement of fibers, and the sheets can be cross-plied to provide a 0/90 X-ply configuration. A polyethylene film can be applied over each uni-ply ballistic resistant sheet prior to joining the sheets with adhesive resin to form the 0/90 X-ply ballistic resistant sheet 250.

Vectorply Corporation, located in Phenix City, Ala. manufactures a variety of stitch-bonded multiaxial fabrics. Stitch-bonded multiaxial fabrics can include cross-plies of high-performance fabrics that are stitched together. In one example, a quad-axial stitch-bonded fabric can include four plies arranged at 0, 90, 45, and −45 degrees, respectively and bonded with tricot stitching. Each ply can be made of a plurality of unilaterally arranged fibers, such as carbon fibers, Kevlar fibers, or UHMWPE fibers. The stitch style and density can alter the performance of the fabric. The stitch pattern can be, for example, chain, tricot, or modified tricot. In a manufacturing process, needles can be mounted on a stitch bar, which can simultaneously move vertically and horizontally to form a desired stitch pattern. Stitch yarn can be polyester, fiberglass, nylon, Nomex, aramid fiber, UHMWPE (e.g. Honeywell Spectra) fiber, or carbon fiber.

Structural Vehicle Door Constructed from UHWMPE Ballistic Sheets

The ballistic resistant vehicle door 500 can include a plurality of ballistic sheets made of UHMWPE, which can have an average molecular weight between about two million and six million. The ballistic sheets can be arranged according to a two-dimensional shape to form a stack of ballistic sheets (e.g. 515, 540) that can be incorporated into a door structure, such as an inner or outer door structure (e.g. 505, 530). In one example, the two-dimensional shape can coincide with, or be instructed by, the shape of an original vehicle door 300 that the ballistic resistant vehicle door 500 will replace. The number of ballistic sheets incorporated in the stack (e.g. 515, 540) can vary depending on an anticipated threat level. In some examples, the number of ballistic sheets in the stack (e.g. 515, 540) can be about 10-20, 20-100, 100-180, 180-220, 220-260, at least 100, or at least 260. Where even greater ballistic performance is required, the number of ballistic sheets in the stack (e.g. 515, 540) can be increased to about 260-500, 500-1,000, or 1,000-1,200. The number of ballistic sheets in the stack (e.g. 515, 540) can depend on the thickness of the UHMWPE ballistic sheet material. If the thickness of each ballistic sheet is increased, the overall number of ballistic sheets can be reduced. Regardless of the thickness of each ballistic sheet or the overall number of ballistic sheets, the stack (e.g. 515, 540) of ballistic sheets can have a thickness of about 0.125-0.5, 0.5-1.0, or 1.0-2.5 inches. Where even greater ballistic performance is required, the thickness of the stack (e.g. 515, 540) of ballistic sheets can be increased to about 2.5-4.0, 4.0-6.0, 6.0-8.0, or 8.0-10 inches. In instances where the ballistic resistant vehicle door 500 is intended to have similar or nearly identical dimension as the original door 300, the thickness of the stack (e.g. 515, 540) of ballistic sheets will be constrained by the dimensions of the original door. The thickness of the stack (e.g. 515, 540) may also be constrained by space requirements of components (e.g. power window motor, door lock, mechanical linkage, wiring harness, etc.) that are installed within the door.

In one example, the ballistic sheets can be arranged in a homogeneous stack (e.g. 515, 540) where all ballistic sheets in the stack are made from the same type of UHMWPE ballistic sheet material, such as TENSYLON sheet material. In other examples, any of the others suitable types of ballistic sheets (e.g. sheets made of aramid or glass fibers, sheets made of ceramic, or sheets made of metal) can be interspersed in the stack (e.g. 515, 540) of UHMWPE ballistic sheet material to alter the ballistic performance of the stack. In another example, a sheet of film adhesive, such as sheet of film adhesive available from Collano AG, can be interspersed in the stack (e.g. 515, 540) of ballistic sheets to alter the ballistic performance of the stack. In particular, a sheet of adhesive film can be incorporated within the stack near a strike face side of the stack (e.g. 515, 540) to improve stab resistance of the stack. A sheet of adhesive film can be incorporated within the stack (e.g. 515, 540) near a wear face side of the stack to improve back face deformation of the stack.

The stack (e.g. 515, 540) of UHMWPE ballistic sheets can be heated to form a laminated stack of ballistic sheets. The heat can be provided by, for example, an infrared oven, autoclave, hydroclave, conventional oven, or any other suitable heat source. In one example, each UHMWPE ballistic sheet can be coated with a resin layer made of a thermoplastic polymer. The resin layer can have a melting point in the range of about 240-260 degree F. The resin layer can be uniformly or non-uniformly distributed onto each ballistic sheet. In one example, the resin layer can be spattered onto the ballistic sheet. In another example, the resin layer can be applied in a uniform layer. In yet another example, the resin layer can be an adhesive film applied to the ballistic sheet. During the heating process, the temperature of the stack of ballistic sheets can be increased to about 240-275 degrees to promote softening or melting of the resin layer on the ballistic sheets, which can promote bonding of adjacent ballistic sheets.

During heating of the stack of ballistic sheets, the outer portions of the stack (e.g. 515, 540) may increase in temperature faster than the inner portions of the stack. To ensure adequate heating of the resin layers on the inner portions of the ballistic sheets in the stack, the heating step may have a duration of at least 5 minutes. The duration may depend on the number of sheets in the stack and the chemical composition of the resin layers on each ballistic sheet. In certain examples, the duration may be about 15-30, 30-45, 45-60, 60-120, 120-240, or 240-480 minutes. The proper duration can be determined through experimentation (e.g. by implanting a thermocouple within a sample stack) or by employing a computational heat transfer program to quantify heat transfer rates and determine when the center of the stack (e.g. 515, 540) will reach a target temperature. It can be desirable to increase the temperature of all portions of the stack (e.g. 515, 540) of ballistic sheets to a temperature at, near, or above the melting or softening point of the resin layer of each ballistic sheet to achieve lamination of the ballistic sheets in the stack.

### Waterproof Cover or Coating

In some instances, it may be desirable to encase the structural ballistic resistant door 500 in a cover or coating. In one example, the cover or coating can be a waterproof cover, thereby producing a waterproof ballistic resistant door 500. The cover or coating can be adapted to prevent the ingress of liquid through the cover or coating toward the ballistic sheets encased by the cover or coating. Preventing water ingress can be desirable, since moisture can negatively affect the performance of the ballistic sheets. In particular, moisture can negatively affect tensile strength of certain fibers (e.g. aramid fibers) within the ballistic sheets, thereby resulting in the sheets being less effective at dissipating impact energy from a projectile.

The cover can be made from any suitable material such as, for example, rubber, NYLON, RAYON, ripstop NYLON, carbon fiber, fiberglass, CORDURA, polyvinyl chloride (PVC), polyurethane, silicone elastomer, fluoropolymer, or any combination thereof. The coating can include polyurethane, polyuria, or epoxy, such as a coating sold by Rhino Linings Corporation, located in San Diego, Calif. In another example, the cover and coating can include any suitable material and coated with a waterproof material such as, for example, rubber, PVC, polyurethane, polytetrafluoroethylene, silicone elastomer, fluoropolymer, wax, or any combination thereof. In one example, the cover and coating can be made from NYLON coated with PVC. In another example, the cover and coating can be made from NYLON coated with thermoplastic polyurethane. The cover and coating can be made of any suitable material, such as about 50, 70, 200, 400, 600, 840, 1050, or 1680-denier NYLON coated with thermoplastic polyurethane. In yet another example, the cover and coating can be made from 1000-denier CORDURA coated with thermoplastic polyurethane.

In addition to protecting the ballistic sheets from water ingress, the cover or coating can be made of a chemically-resistant material to protect the ballistic sheets if the panel is exposed to acids or bases. Certain acids and bases can cause the tenacity of certain fibers, such as aramid fibers, to degrade over time, where “tenacity” is a measure of strength of a fiber or yarn. It is therefore desirable, in certain applications, for the cover or coating to be resistant to acids and bases to prevent the cover or coating from deteriorating when exposed to acids or bases. Deterioration of the cover or coating would be undesirable, since it would permit the acids and bases to breach the cover or coating and reach the stack of ballistic sheets inside the cover or coating. To this end, the cover can be made of a chemically resistant material or can include a chemically resistant coating on an outer surface of the cover. For instance, the cover can include a thermoplastic polymer coating on an outer surface of the cover. Examples of chemically-resistant thermoplastic polymer that can be used as a coating on the cover include polypropylene, low-density polyethylene, medium-density polyethylene, high-density polyethylene, ultra-high-molecular-weight polyethylene, and polytetrafluoroethylene (e.g. TEFLON).

The cover or coating can be made of a flame-resistant or flame-retardant material. In one example, the cover can include a base material with a flame-resistant or flame-retardant coating impregnated in the base material. In another example, the cover can include a base material coated with a flame-resistant or flame-retardant material. The flame-resistant or flame-retardant coating can include a phenolic resin, a phenolic/epoxy composite, NOMEX, an organohalogen compound (e.g. chlorendic acid derivative, chlorinated paraffin, decabromodiphenyl ether, decabromodiphenyl ethane, brominated polystyrene, brominated carbonate oligomer, brominated epoxy oligomer, tetrabromophthalic anyhydride, tetrabromobisphenol A, or hexabromocyclododecane), an organophosphorus compound (e.g. triphenyl phosphate, resorcinol bis(diphenylphosphate), bisphenol A diphenyl phosphate, tricresyl phosphate, dimethyl methylphosphonate, aluminum diethyl phosphinate, brominated tris, chlorinated tris, or tetrekis(2-chlorethyl)dichloroisopentyldiphosphate, antimony trioxide, or sodium antimonite), or a mineral (e.g. aluminium hydroxide, magnesium hydroxide, huntite, hydromagnesite, red phosphorus, or zinc borate).

The cover, along with the ballistic resistant vehicle door 500, can be heated and subjected to a vacuum bagging process, thereby partially or fully bonding an inner surface of the cover to the outer surfaces of the ballistic resistant vehicle door 500. The cover can include a temperature sensitive adhesive or a layer of resin on an inner surface. The cover can be heated to promote full or partial bonding of the inner surface of the cover to the outer surfaces of the ballistic resistant vehicle door 500 due to the layer of adhesive or resin disposed on the inner surface of the cover. In one example, the cover can be made of a material that is coated with polyurethane, polypropylene, vinyl, polyethylene, or a combination thereof, on the inner surface the cover. Heating the cover to a temperature above the melting point of the adhesive or resin and then cooling the cover below the melting point of the adhesive or resin can result in bonding of the inner surface of the cover to outer surfaces of the ballistic resistant vehicle door 500

In some examples, the cover can be made of ripstop NYLON and coated with polyurethane. The cover can be made of ripstop NYLON with a polyurethane coating that is about 0.1-1.5, 0.1-0.75, 0.1-0.5, or 0.25 mil thick. In some examples, the cover can be made of about 70-denier ripstop NYLON with a polyurethane coating that is about 0.1-1.5, 0.1-0.75, 0.1-0.5, or 0.25 mil thick. The polyurethane coating can be provided on an inner surface of the cover as noted above. A durable water repellant finish can be provided on an outer surface of the cover to further enhance performance. Suitable polyurethane-coated ripstop NYLON materials are commercially available under the trademark X-PAC from Rockywoods Fabrics, LLC of Loveland, Colo.

### Heat Sealing

As discussed above, the ballistic resistant vehicle door 500, or inner and outer portions of the door (505, 530), can be encased by a protective cover. The outer perimeter of the cover can be heat-sealed to prevent water ingress. Heat sealing is a process where one material is joined to another (e.g. one thermoplastic is joined to another thermoplastic) using heat and pressure. During the heat sealing process, a heated die or sealing bar can apply heat and pressure to a specific contact area or path to seal or join two materials together. When heat-sealing the perimeter of the cover, the presence of a thermoplastic material proximate the contact area can promote sealing in the presence of heat and pressure. In one example, the cover can include thermoplastic polyurethane proximate the contact area to permit heat sealing. The cover can be made of a first portion and a second portion, and the heat sealing process can be used to join the first portion to the second portion, thereby encapsulating the door 500, or a portion of the door, in a waterproof enclosure.

### Ballistic Sheet Resin

Ballistic sheets can be coated or impregnated with one or more resins. Certain resins, such as resins made of thermoplastic polymers, may include long chain molecules. The long chain molecules may be held close to each other by weak secondary forces. Upon heating, the secondary forces may be reduced, thereby permitting sliding of the long chains of molecules and resulting in visco-plastic flow and ease in molding. Heating of the ballistic sheets may cause softening of the resin, and the resin may become tacky as it softens. Applying pressure to the stack (e.g. 515, 540) of ballistic sheets when the resin is softened and tacky may result in resin layers on adjacent ballistic sheets becoming comingled, and when the door is subsequently cooled and the temperature of the resin is reduced, adjacent ballistic sheets may be partially or fully bonded to each other. In one example, ballistic sheets in a door may be coated or impregnated with a thermoplastic resin (e.g. polypropylene resin), and the thermoplastic resin may have a melting point of about 248 degrees F. In one example, the stack (e.g. 515, 540) of ballistic sheets may be heated to a temperature near 248 degrees F. to cause softening of the thermoplastic resin, and pressure may be applied to the stack (e.g. 515, 540) to press adjacent ballistic sheets together, which may result in comingling of resin layers on adjacent ballistic sheets. When the door can is cooled and the temperature of the resin is reduced, adjacent ballistic sheets may be partially or fully bonded to each other, resulting in a laminated stack (e.g. 515, 540) of ballistic sheets.

When forming a ballistic resistant vehicle door portion (e.g. 505, 530) from one or more ballistic sheets containing one or more resins, a suitable processing temperature for a ballistic resistant door portion can be dictated, at least partly, by the resin type and resin content (i.e. percent weight) of the ballistic sheets. Selecting a resin with a lower melting point may reduce the target processing temperature for the door portion (e.g. 505, 530), and selecting a resin with a higher melting point may increase the target processing temperature for the door portion. The extent of lamination (e.g. full or partial bonding) that occurs between adjacent ballistic sheets in the stack (e.g. 515, 540) can be controlled, at least in part, by resin selection, resin content, and process temperature and pressure.

### Wide-Ranging Applications

The apparatuses and methods described herein can be used in a wide range of applications that require structural support and an ability to dissipate impact energy from ballistic threats. The structural ballistic resistant apparatuses 500 and methods described can be used in a wide variety of applications, including, but not limited to, vehicle armor, protective cases for computers or other electronic devices (e.g. smartphones, rechargeable battery packs, helmet cameras, flashlights, night vision devices, etc.), armored boxes, athletic equipment (e.g. helmets, protective pads, goal posts, backboards, baseball bats, hockey sticks, lacrosse sticks, golf clubs, bicycle frames, downhill skis, snowboards, surfboards, wakeboards, water skis, etc.), barricades, oil and gas pipelines, oil and gas pipeline coverings, doors, furniture (e.g. tables, chairs, desks, couches, bookcases, trunks, hutches, cabinets, entertainment centers, etc.), wall inserts, gunner protection kits (GPK), body armor (e.g. small arms protective insert (SAPI) plates, side-SAPI plates, military footwear, personal watercraft hulls, protective vests, combat helmets), public speaking podiums, vehicle (e.g. motorcycle, all-terrain vehicle, aircraft, etc.) fairings, bank counters, safe rooms, prisoner holding cells, theater seats, airline seats, cockpit doors for aircraft, portable military dwellings, or boat or ship components (e.g. hulls, structural supports, periscopes, masts, and decking) The structural ballistic resistant apparatuses described herein can replace components that are purely structural (e.g I-beams, studs, square tubing, round tubing, etc.) to provide a component that is both structural and ballistic resistant.

The ballistic resistant apparatuses and methods described herein can serve as spall liners in tanks and other armored vehicles to protect against, for example, the effects of high explosive squash head (HESH) anti-tank shells. Spall liners can serve as secondary armor to protect occupants and equipment within an armored vehicle having a primary armor made of steel, ceramic, aluminum, or titanium. In the event of an impact or explosion proximate an outer surface of the armored vehicle (e.g. tank or HMMWV), the spall liner can prevent or reduce fragmentation into the vehicle cabin, which is desirable, since fragmentation into the vehicle cabin can potentially cause more extensive injuries to vehicle occupants than the original explosion due if fragments ricochet within the cabin. When used as a spall liner, the structural ballistic resistant apparatus can be positioned between exterior steel armor plating of the military vehicle and the cabin of the vehicle. In other examples, the structural ballistic resistant apparatus can serve as a body or chassis component of the vehicle (e.g. tank, MRAP, HMMWV, light tactical vehicle, all-terrain vehicle (ATV) or commercially-available vehicle).

The structural ballistic resistant apparatus described herein can be incorporated into vehicle doors, floors, headliners, fenders, dashboards, firewalls, floor mats, roofs, and seats to protect the vehicle, occupants, equipment, and ammunitions in the vehicle from projectiles. Due to their relative light weight and low cost, the structural ballistic resistant apparatuses 500 described herein can be also incorporated into consumer vehicles without significantly reducing fuel economy or increasing vehicle cost. In addition to protecting against ballistic threats, the apparatuses may improve certain aspects of vehicle performance. For instance, the apparatus may increase the stiffness of the vehicle frame and improve high-speed handling of the vehicle.

The structural ballistic resistant apparatuses described herein can be used to protect commercial, governmental, or residential buildings (e.g. banks, homes, schools, office buildings, prisons, restaurants, laboratories, churches, and convenience stores) from ballistic threats. The structural apparatuses can be incorporated into walls, floors, or ceilings (e.g. in homes, banks, or law enforcement facilities). In one example, the apparatus can be incorporated into a wall and can be concealed by or within drywall. In this way, the structural ballistic resistant apparatus may not be visible and may not detract from the appearance of the wall. The structural ballistic resistant apparatus can be incorporated into manufactured (i.e. pre-made) walls that are delivered to a construction site, or the apparatus can be inserted into walls that are built on site. In another example, the structural ballistic resistant apparatus can serve as a wall component and can include an exterior covering (e.g. drywall) that can be painted to look like a traditional wall in a home or office building. In this example, the structural ballistic resistant apparatus may include one or more structural members that support the panel in an upright position and allow the panel to effectively support the weight of a roof, beam, or other load, located above the panel and transfer that weight to, for example, a floor or foundation of the building.

The structural ballistic resistant apparatus can be incorporated into a portable or stationary fuel tank. The fuel tank can be a component of a vehicle (e.g. HMMWV, MRAP, submarine, ATV, jet, airplane, or drone), a freestanding tank for an oil refinery, or a primary tank attached to a tanker truck. The fuel tank can include a laminated stack of ballistic sheets covered by a structural member made of a composite material, such as a carbon fiber composite material or a fiberglass composite material, according to any of the methods described herein.

The structural ballistic resistant apparatus can be used in a fuselage of a submarine, airplane, satellite, missile, torpedo, or other weapon system. The fuselage or weapon system can include a laminated stack of ballistic sheets can be encased by a structural member that can be made of a composite material, such as a carbon fiber composite material or a fiberglass composite material, according to any of the methods described herein.

The structural ballistic resistant apparatus described herein can form a pipeline (e.g. petroleum or gas pipeline) or tank capable of defending against ballistic threats. In one example, a section of pipeline (e.g. round steel tubing) adapted to serve as a conduit for any type of liquid or gas (e.g. natural gas, oil, gasoline, or diesel fuel) can be encased with a plurality of UHMWPE ballistic sheets forming a laminated stack. The laminated stack of ballistic sheets can be encased by a structural member that can be made of a composite material, such as a carbon fiber composite material or a fiberglass composite material, according to any of the methods described herein.

In some instances, a ballistic resistant structure for use in commercial, residential, governmental, automotive, aerospace, or infrastructure applications can include a first ballistic resistant component spaced apart from a second ballistic resistant component by a distance, similar to how the first and second stacks of ballistic sheets in FIG. 9A are spaced apart. Separating the first and second ballistic resistant components by a distance can improve the ballistic performance of the structure by, for example, allowing a projectile to rotate or otherwise deviate from its original flight path as it exits the first ballistic resistant component and before it strikes the second ballistic resistant component. Consequently, the projectile will experience yaw, which will significantly reduce its likelihood of passing through the second ballistic component, since a larger frontal area of the projectile will contact the second ballistic resistant component, making it far more likely that the second ballistic component will successfully defeat the projectile. Spacing the first and second ballistic components apart can also improve the structural integrity of the structure.

In some examples, the ballistic resistant structure for use in commercial, residential, governmental, automotive, aerospace, or infrastructure applications can include a first ballistic resistant structure having a first plurality of ballistic sheets and a second ballistic resistant structure having a second plurality of ballistic sheets. The first ballistic resistant structure can include a first structural composite cover encasing the first plurality of ballistic sheets. The first structural composite cover can be made of a combination of carbon fiber fabric and resin. The first structural composite cover can be formed using a vacuum bagging process performed within an autoclave or other suitable machine or device capable of applying heat and pressure concurrently. The ballistic resistant structure can include a second structural composite cover encasing the second plurality of ballistic sheets. The second structural composite cover can include a combination of carbon fiber fabric and resin. The second structural composite cover can be formed using a vacuum bagging process performed within an autoclave or other suitable machine or device capable of applying heat and pressure. The first and second ballistic resistant components can be spaced apart by a distance 525. More specifically, the first and second ballistic resistant components can be arranged in planes that are about parallel to each other and offset by a distance 525, similar to how the first and second stacks of ballistic sheets (515, 540) are offset in FIG. 9A. The proper length of the offset 525 will be influenced by the type, mass, and velocity of the projectile the structure 500 must defeat. The proper length of the offset will also be influenced by the ballistic performance of the first and second ballistic resistant structures. Consequently, the proper length of the offset 525 between the first and second ballistic resistant structures will not be identical in all cases and should be adjusted based on quantifiable variables mentioned above and confirmed through testing. In some examples, the length of the offset 525 can be at least 0.25 inches. In other examples, the length of the offset 525 can be about 0.5-36, 1-24, 5-18, 2-6, or 0.5-3 inches. In still other examples, the length of the offset 525 can be at least two times longer, at least 5 times longer, or at least ten times longer than the length of the projectile, to provide a gap 525 that is sufficiently large to permit the projectile to experience yaw as it travels through the gap 525. In some examples, the gap 525 can be air. In other examples, the gap 525 can be filled with a suitable filler material, such as a metal wire mesh or matrix, that increases the likelihood of the projectile experiencing yaw as it travels from the first ballistic resistant component to the second ballistic resistant component.

### Ballistic Performance Standards

The ballistic resistant panels 100 described herein can be configured to comply with certain performance standards, such as those set forth in NIJ Standard-0101.06, Ballistic Resistance of Body Armor (July 2008), which is hereby incorporated by reference in its entirety. The National Institute of Justice (NIJ), which is part of the U.S. Department of Justice (DOJ), is responsible for setting minimum performance standards for law enforcement equipment, including minimum performance standards for police body armor. Under NIJ Standard-0101.06, armor is classified into five categories (II-A, II, III-A, III, IV) based on ballistic performance of the armor. Type II-A armor that is new and unworn is tested with 9 mm Full Metal Jacketed Round Nose (FMJ RN) bullets with a specified mass of 8.0 g (124 gr) and a velocity of 373 m/s±9.1 m/s (1225 ft/s±30 ft/s) and with 0.40 S&W Full Metal Jacketed (FMJ) bullets with a specified mass of 11.7 g (180 gr) and a velocity of 352 m/s±9.1 m/s (1155 ft/s±30 ft/s). Type II armor that is new and unworn is tested with 9 mm FMJ RN bullets with a specified mass of 8.0 g (124 gr) and a velocity of 398 m/s±9.1 m/s (1305 ft/s±30 ft/s) and with 0.357 Magnum Jacketed Soft Point (JSP) bullets with a specified mass of 10.2 g (158 gr) and a velocity of 436 m/s±9.1 m/s (1430 ft/s±30 ft/s). Type III-A armor that is new and unworn shall be tested with 0.357 SIG FMJ Flat Nose (FN) bullets with a specified mass of 8.1 g (125 gr) and a velocity of 448 m/s±9.1 m/s (1470 ft/s±30 ft/s) and with 0.44 Magnum Semi Jacketed Hollow Point (SJHP) bullets with a specified mass of 15.6 g (240 gr) and a velocity of 436 m/s±9.1 m/s (1430 ft/s±30 ft/s). Type III flexible armor shall be tested in both the “as new” state and the conditioned state with 7.62 mm FMJ, steel jacketed bullets (U.S. Military designation M80) with a specified mass of 9.6 g (147 gr) and a velocity of 847 m/s±9.1 m/s (2780 ft/s±30 ft/s). Type IV flexible armor shall be tested in both the “as new” state and the conditioned state with .30 caliber AP bullets (U.S. Military designation M2 AP) with a specified mass of 10.8 g (166 gr) and a velocity of 878 m/s±9.1 m/s (2880 ft/s±30 ft/s).

The ballistic resistant panels 100 described herein can be configured to comply with certain performance standards, such as those set forth in NIJ Standard-0108.01, Ballistic Resistant Protective Materials (September 1985), which is hereby incorporated by reference in its entirety. Under NIJ Standard-0108.01, ballistic resistant protective materials are classified into six categories (I, II-A, II, III-A, III, IV) based on ballistic performance of the armor. Type I armor protects against the standard test rounds as defined in section 5.2.1 of NIJ Standard-0108.01. Type I armor also provides protection against lesser threats such as 12 gauge No. 4 lead shot and most handgun rounds in calibers 25 and 32. Type II-A armor protects against the standard test rounds as defined in section 5.2.2 of NIJ Standard-0108.01. It also provides protection against lesser threats such as 12 gauge 00 buckshot, 45 Auto., 38 Special and some other factory loads in caliber 357 Magnum and 9 mm, as well as the threats mentioned in section 2.2.1 of NIJ Standard-0108.01. Type II armor protects against the standard test rounds as defined in section 5.2.3 of NIJ Standard-0108.01. It also provides protection against most other factory loads in caliber 357 Magnum and 9 mm, as well as threats mentioned in section 2.2.1 and 2.2.2 of NIJ Standard-0108.01. Type III-A armor protects against the standard test rounds as defined in section 5.2.4 of NIJ Standard-0108.01. It also provides protection against most handgun threats as well as the threats mentioned in sections 2.2.1 through 2.2.3 of NIJ Standard-0108.01. Type III armor protects against the standard test round as defined in section 5.2.5 of NIJ Standard-0108.01. It also provides protection against most lesser threats such as 223 Remington (5.56 mm FMJ), 30 Carbine FMJ, and 12 gauge rifle slug, as well as the threats mentioned in sections 2.2.1 through 2.2.4 of NIJ Standard-0108.01. Type IV armor protects against the standard test round as defined in section 5.2.6 of NIJ Standard-0108.01. It also provides at least single hit protection against the threats mentioned in sections 2.2.1 through 2.2.5 of NIJ Standard-0108.01.

Under NIJ Standard-0108.01, Type III-A, the armor can be tested with a 44 magnum and with a Submachine Gun (SMG) 9 mm. The first test weapon can be a 44 Magnum handgun or test barrel. The use of a handgun with a 14 to 16 cm (5.5 to 6.25 in) barrel is suggested. Test bullets shall be 44 Magnum, lead semiwadcutter with gas checks, nominal masses of 15.55 g (240 gr), and measured velocities of 426 m/s±15 m/s (1400 ft/s±50 ft/s). The second test weapon can be a 9 mm SMG or test barrel. The use of a test barrel with a 24 to 26 cm (9.5 to 10.25 in) barrel is suggested. Test bullets shall be 9 mm full metal jacketed (FMJ), with nominal masses of 8.0 g (124 gr) and measured velocities of 426 m/s±15 m (1400 ft/s±50 ft/s).

The term “ballistic limit” describes the impact velocity required to perforate a target with a certain type of projectile. To determine the ballistic limit of a target, a series of experimental tests must be conducted. During the tests, the velocity of the certain type of projectile is increased until the target is perforated. The term “V₅₀” designates the velocity at which half of the certain type of projectiles fired at the target will penetrate the target and half will not.

In one example, a structural ballistic resistant vehicle door can include an inner door structure and an outer door structure. The inner door structure can include a rigid carbon fiber composite material or a rigid fiberglass composite material. The outer door structure can be joined to the inner door structure to form the structural ballistic resistant vehicle door. The outer door structure can include a stack of ballistic sheets having a top surface and a bottom surface opposite the top surface. One or more ballistic sheets in the stack of ballistic sheets can be partially or fully bonded to an adjacent ballistic sheet in the stack of ballistic sheets. The outer door structure can also include a first structural member adjacent to the top surface of the stack of ballistic sheets and a second structural member adjacent to the bottom surface of the stack of ballistic sheets. The first structural member can be made of a rigid carbon fiber composite material or a rigid fiberglass composite material. Likewise, the second structural member can be made of a rigid carbon fiber composite material or a rigid fiberglass composite material. The second structural member can be joined to the first structural member to form a three-dimensional structural exterior layer that encapsulates the stack of ballistic sheets.

The structural ballistic resistant vehicle door can include a first film adhesive layer between the first structural member and the top surface of the stack of ballistic sheets. The first film adhesive layer comprises a thermoplastic polymer. The structural ballistic resistant vehicle door can include a second film adhesive layer between the second structural member and the bottom surface of the stack of ballistic sheets. The second film adhesive layer comprises a thermoplastic polymer. The stack of ballistic sheets can include about 10-20, 20-100, at least 100, 180-220, 220-260, at least 260, 260-500, 500-1,000, or 1,000-1,200 ballistic sheets. The ballistic sheets within the stack of ballistic sheets can be high modulus bidirectional pre-impregnated composite sheets. One or more ballistic sheets within the stack of ballistic sheets can be made of ultra-high-molecular-weight polyethylene having an average molecular weight between about two million and six million. The ultra-high-molecular-weight polyethylene can have a melting temperature of about 260-300 or 275-285 degrees F.

In another example, a structural ballistic resistant vehicle door can include a stack of ballistic sheets having a top surface and a bottom surface opposite the top surface. One or more ballistic sheets in the stack of ballistic sheets can be partially or fully bonded to an adjacent ballistic sheet in the stack of ballistic sheets. A first structural member can be adjacent to the top surface of the stack of ballistic sheets. The first structural member can be made of a rigid carbon fiber composite material or a rigid fiberglass composite material. A second structural member can be adjacent to the bottom surface of the stack of ballistic sheets. The second structural member can be made of a rigid carbon fiber composite material or a rigid fiberglass composite material. The second structural member can be joined to the first structural member to form a three-dimensional structural exterior layer that encapsulates the stack of ballistic sheets. The first and second structural members can provide a compressive force against opposing exterior surfaces of the stack of ballistic sheets to resist delamination of the stack of ballistic sheets when a projectile strikes the structural ballistic resistant vehicle door.

The stack of ballistic sheets can include about 10-20, 20-100, at least 100, 180-220, 220-260, at least 260, 260-500, 500-1,000, or 1,000-1,200 ballistic sheets. The ballistic sheets within the stack of ballistic sheets can be high modulus bidirectional pre-impregnated composite sheets. One or more ballistic sheets within the stack of ballistic sheets can be made of ultra-high-molecular-weight polyethylene having an average molecular weight between about two million and six million. The ultra-high-molecular-weight polyethylene can have a melting temperature of about 275-285 degrees F.

The structural ballistic resistant vehicle door can include a first film adhesive layer between the first structural member and the top surface of the stack of ballistic sheets. The first film adhesive layer can be a thermoplastic polymer. The structural ballistic resistant vehicle door can include a second film adhesive layer between the second structural member and the bottom surface of the stack of ballistic sheets. The second film adhesive layer can be a thermoplastic polymer.

In yet another example, a structural ballistic resistant vehicle door can include an outer door structure and an inner door structure. The outer door structure can include a rigid carbon fiber composite material or a rigid fiberglass composite material. The inner door structure can be joined to the outer door structure to form the structural ballistic resistant vehicle door. The inner door structure can include a stack of ballistic sheets having a top surface and a bottom surface opposite the top surface. One or more ballistic sheets in the stack of ballistic sheets can be partially or fully bonded to an adjacent ballistic sheet in the stack of ballistic sheets. The inner door structure can include a first structural member and a second structural member. The first structural member can be adjacent to the top surface of the stack of ballistic sheets. The first structural member can be made of a rigid carbon fiber composite material or a rigid fiberglass composite material. The second structural member can be adjacent to the bottom surface of the stack of ballistic sheets. The second structural member can be made of a rigid carbon fiber composite material or a rigid fiberglass composite material. The second structural member can be joined to the first structural member to form a three-dimensional structural exterior layer that encapsulates the stack of ballistic sheets.

The stack of ballistic sheets can include about 10-20, 20-100, at least 100, 180-220, 220-260, at least 260, 260-500, 500-1,000, or 1,000-1,200 ballistic sheets. One or more ballistic sheets within the stack of ballistic sheets can include ultra-high-molecular-weight polyethylene having an average molecular weight between about two million and six million. The ultra-high-molecular-weight polyethylene has a melting temperature of about 275-285 degrees F.

The structural ballistic resistant vehicle door can include a first film adhesive layer between the first structural member and the top surface of the stack of ballistic sheets. The first film adhesive layer can be a thermoplastic polymer. Likewise, the structural ballistic resistant vehicle door of claim can include a second film adhesive layer between the second structural member and the bottom surface of the stack of ballistic sheets. The second film adhesive layer can be a thermoplastic polymer.

In one example, a structural ballistic resistant vehicle door can include an inner door structure joined to an outer door structure. The inner door structure can include a rigid carbon fiber composite material or a rigid fiberglass composite material. The outer door structure can be spaced apart from the inner door structure by a distance. The outer door structure can include a stack of ballistic sheets. The stack can include a top surface and a bottom surface opposite the top surface. One or more ballistic sheets in the stack of ballistic sheets can be partially or fully bonded to an adjacent ballistic sheet in the stack of ballistic sheets. The outer door structure can include a first structural member adjacent to the top surface of the stack of ballistic sheets. The first structural member can include a rigid carbon fiber composite material or a rigid fiberglass composite material. The outer door structure can include a second structural member adjacent to the bottom surface of the stack of ballistic sheets. The second structural member can include a rigid carbon fiber composite material or a rigid fiberglass composite material. The second structural member can be joined to the first structural member to form a three-dimensional structural exterior layer that encapsulates the stack of ballistic sheets. The door can include a first film adhesive layer between the first structural member and the top surface of the stack of ballistic sheets. The first film adhesive layer can include a thermoplastic polymer and can adhere the first structural member to the top surface of the stack of ballistic sheets. The door can include a second film adhesive layer between the second structural member and the bottom surface of the stack of ballistic sheets. The second film adhesive layer can include a thermoplastic polymer and can adhere the second structural member to the bottom surface of the stack of ballistic sheets. The structural ballistic resistant vehicle door can include a first structural member and the second structural member. The first and second structural members can each include woven or nonwoven carbon fiber fabric impregnated with an epoxy resin. The stack of ballistic sheets can include about 10-25, 20-100, 80-220, 200-260, 250-500, or 450-1,200 ballistic sheets. The ballistic sheets within the stack of ballistic sheets can be high modulus bidirectional pre-impregnated composite sheets. The structural ballistic resistant vehicle door can have a ballistic performance that meets or exceeds threat level III requirements set forth in NIJ Standard 0108.01. One or more ballistic sheets within the stack of ballistic sheets can include ultra-high-molecular-weight polyethylene having an average molecular weight of about two million to six million. The inner door structure can include a second stack of ballistic sheets. The second stack can include a top surface and a bottom surface opposite the top surface. One or more ballistic sheets in the second stack of ballistic sheets can be partially or fully bonded to an adjacent ballistic sheet in the stack of ballistic sheets. The inner door structure can include a third structural member adjacent to the top surface of the second stack of ballistic sheets. The third structural member can include a rigid carbon fiber composite material or a rigid fiberglass composite material. The inner door structure can include a fourth structural member adjacent to the bottom surface of the stack of ballistic sheets. The fourth structural member can include a rigid carbon fiber composite material or a rigid fiberglass composite material. The fourth structural member can be joined to the third structural member to form a three-dimensional structural exterior layer that encapsulates the second stack of ballistic sheets. The distance between the inner door structure and the outer door structure can be about 0.5-3, 2-6, 4-12, or 10-18 inches. The distance can be at least two times greater than a length of a projectile the structural ballistic resistant door is intended to protect against.

In another example, a structural ballistic resistant vehicle door can include a stack of ballistic sheets. The stack can include a top surface and a bottom surface opposite the top surface. One or more ballistic sheets in the stack of ballistic sheets can be partially or fully bonded to an adjacent ballistic sheet in the stack of ballistic sheets. The door can include a first structural member adjacent to the top surface of the stack of ballistic sheets. The first structural member can include a rigid carbon fiber composite material or a rigid fiberglass composite material. The door can include a second structural member adjacent to the bottom surface of the stack of ballistic sheets. The second structural member can include a rigid carbon fiber composite material or a rigid fiberglass composite material. The second structural member can be joined to the first structural member to form a three-dimensional structural exterior layer that encapsulates the stack of ballistic sheets. The first and second structural members can provide a compressive force against opposing exterior surfaces of the stack of ballistic sheets to resist delamination of the stack of ballistic sheets when the structural ballistic resistant vehicle door is struck by a projectile. The stack of ballistic sheets can include about 10-20, 20-100, at least 100, 180-220, 220-260, at least 260, 260-500, 500-1,000, or 1,000-1,200 ballistic sheets. One or more ballistic sheets within the stack of ballistic sheets can include aramid fibers arranged unilaterally. The structural ballistic resistant vehicle door can have a ballistic performance that meets or exceeds threat level III requirements set forth in NIJ Standard 0108.01. One or more ballistic sheets within the stack of ballistic sheets can include ultra-high-molecular-weight polyethylene having an average molecular weight between about two million and six million. The door can include a first film adhesive layer between the first structural member and the top surface of the stack of ballistic sheets. The first film adhesive layer can include a thermoplastic polymer. The door can include a ceramic member positioned between the first structural member and the top surface of the stack of ballistic sheets. The ceramic member can include silicon carbide, boron carbide, titanium carbide, tungsten carbide, zirconia toughened alumina, or high-density aluminum oxide. The door can include a plurality of ceramic members arranged in an array between the first structural member and the top surface of the stack of ballistic sheets. The structural ballistic resistant vehicle door can have a ballistic performance that meets or exceeds threat level IV requirements set forth in NIJ Standard 0108.01.

In yet another example, a structural ballistic resistant vehicle door can include an outer door structure. The outer door structure can include a rigid carbon fiber composite material or a rigid fiberglass composite material. The door can include an inner door structure joined to the outer door structure to form the structural ballistic resistant vehicle door. The inner door structure can include a stack of ballistic sheets. The stack can include a top surface and a bottom surface opposite the top surface. One or more ballistic sheets in the stack of ballistic sheets can be partially or fully bonded to an adjacent ballistic sheet in the stack of ballistic sheets. The inner door structure can include a first structural member adjacent to the top surface of the stack of ballistic sheets. The first structural member can include a rigid carbon fiber composite material or a rigid fiberglass composite material. The inner door structure can include a second structural member adjacent to the bottom surface of the stack of ballistic sheets. The second structural member can include a rigid carbon fiber composite material or a rigid fiberglass composite material. The second structural member can be joined to the first structural member to form a three-dimensional structural exterior layer that encapsulates the stack of ballistic sheets. The stack of ballistic sheets can include about 10-20, 20-100, at least 100, 180-220, 220-260, at least 260, 260-500, 500-1,000, or 1,000-1,200 ballistic sheets. One or more ballistic sheets within the stack of ballistic sheets can include ultra-high-molecular-weight polyethylene having an average molecular weight between about two million and six million. One or more ballistic sheets within the stack of ballistic sheets can include aramid fibers arranged unilaterally. The door can include a first film adhesive layer between the first structural member and the top surface of the stack of ballistic sheets. The first film adhesive layer can include polyethylene, polypropylene, ethylene, copolyester, copolyamide, or thermoplastic polyurethane. The first film adhesive layer can adhere the first structural member to the top surface of the stack of ballistic sheets. The door can include a second film adhesive layer between the second structural member and the bottom surface of the stack of ballistic sheets. The second film adhesive layer can include polyethylene, polypropylene, ethylene, copolyester, copolyamide, or thermoplastic polyurethane. The first adhesive film layer can adhere the second structural member to the bottom surface of the stack of ballistic sheets. The outer door structure can include a ceramic member encased by a structural member. The structural member can include a woven or nonwoven carbon fiber fabric infused with a thermoset resin. The structural ballistic resistant vehicle door can have a ballistic performance that meets or exceeds threat level III requirements set forth in NIJ Standard 0108.01.

The particular embodiments or elements of the method disclosed by the description or shown in the figures accompanying this application are not intended to be limiting, but rather exemplary of the numerous and varied embodiments generically encompassed by the method and apparatuses or equivalents encompassed with respect to any particular element thereof. In addition, the specific description of a single embodiment or element of the method may not explicitly describe all embodiments or elements possible; many alternatives are implicitly disclosed by the description and figures.

It should be understood that each element of an apparatus and system and each step of a method may be described by an apparatus term or method term. Such terms can be substituted where desired to make explicit the implicitly broad coverage to which this method is entitled. As but one example, it should be understood that all steps of a method may be disclosed as an action, a means for taking that action, or as an element which causes that action. Similarly, each element of an apparatus may be disclosed as the physical element or the action that physical element facilitates. As but one example, the disclosure of “bond” should be understood to encompass disclosure of the act of “bonding”—whether explicitly discussed or not—and, conversely, where the act of “bonding” is specifically disclose, such disclosure should be understood to also encompass a disclosure of “a bond.” Such alternative terms for each element or step are to be understood to be explicitly included in the description.

In addition, as to each term used, it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

Moreover, for the purposes of the present method, the term “a” or “an” entity refers to one or more of that entity; for example, “a layer of carbon fiber composite material” refers to one or more layers of carbon fiber composite material. As such, the terms “a” or “an,” “one or more,” and “at least one” can be used interchangeably herein. Furthermore, an element “selected from the group consisting of” refers to one or more of the elements in the list that follows, including combinations of two or more of the elements.

All numeric values (e.g. process temperatures, pressures, durations, and numbers of ballistic sheets in a stack) presented herein are assumed to be modified by the term “about,” whether or not explicitly indicated. For the purposes of the methods described herein, ranges may be expressed as from “about” one particular value to “about” another particular value. When such a range is expressed, another embodiment includes from the one particular value to the other particular value. The recitation of numeric ranges by endpoints includes all the numeric values subsumed within that range. A numeric range of one to five includes, for example, the numeric values 1, 1.5, 2, 2.75, 3, 3.80, 4, 5, and so forth. It will be further understood that the endpoints of each of the numeric ranges are significant, both in relation to the other endpoint and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

The foregoing description has been presented for purposes of illustration and description. It is not intended to be exhaustive or to limit the claims to the embodiments disclosed. Other modifications and variations may be possible in view of the above teachings. The embodiments were chosen and described to explain the principles of the invention and its practical applications to enable others skilled in the art to best utilize the invention in various embodiments and various modifications as are suited to the particular use contemplated. It is intended that the claims be construed to include other alternative embodiments of the invention except insofar as limited by the prior art.

What is claimed is:

1. A structural ballistic resistant vehicle door comprising:
an inner door structure, wherein the inner door structure comprises a rigid carbon fiber composite material or a rigid fiberglass composite material; and
an outer door structure joined to the inner door structure to form the structural ballistic resistant vehicle door, the outer door structure spaced apart from the inner door structure by a distance, the outer door structure comprising:
a stack of ballistic sheets, the stack comprising a top surface and a bottom surface opposite the top surface, wherein one or more ballistic sheets in the stack of ballistic sheets is partially or fully bonded to an adjacent ballistic sheet in the stack of ballistic sheets;
a first structural member adjacent to the top surface of the stack of ballistic sheets, the first structural member comprising a rigid carbon fiber composite material or a rigid fiberglass composite material; and
a second structural member adjacent to the bottom surface of the stack of ballistic sheets, the second structural member comprising a rigid carbon fiber composite material or a rigid fiberglass composite material,
wherein the second structural member is joined to the first structural member to form a three-dimensional structural exterior layer that encapsulates the stack of ballistic sheets.

2. The structural ballistic resistant vehicle door of claim 1, further comprising:
a first film adhesive layer between the first structural member and the top surface of the stack of ballistic sheets, wherein the first film adhesive layer comprises a thermoplastic polymer and adheres the first structural member to the top surface of the stack of ballistic sheets; and
a second film adhesive layer between the second structural member and the bottom surface of the stack of ballistic sheets, wherein the second film adhesive layer comprises a thermoplastic polymer and adheres the second structural member to the bottom surface of the stack of ballistic sheets.

3. The structural ballistic resistant vehicle door of claim 1, wherein the first structural member and the second structural member each comprise woven or nonwoven carbon fiber fabric impregnated with an epoxy resin.

4. The structural ballistic resistant vehicle door of claim 1, wherein the stack of ballistic sheets comprises about 10-25, 20-100, 80-220, 200-260, 250-500, or 450-1,200 ballistic sheets.

5. The structural ballistic resistant vehicle door of claim 1, wherein the ballistic sheets within the stack of ballistic sheets are high modulus bidirectional pre-impregnated composite sheets, wherein the structural ballistic resistant vehicle door has a ballistic performance that meets or exceeds threat level III requirements set forth in NIJ Standard 0108.01.

6. The structural ballistic resistant vehicle door of claim 1, wherein one or more ballistic sheets within the stack of ballistic sheets comprise ultra-high-molecular-weight polyethylene having an average molecular weight of about two million to six million.

7. The structural ballistic resistant vehicle door of claim 1, the inner door structure further comprising:
a second stack of ballistic sheets, the second stack comprising a top surface and a bottom surface opposite the top surface, wherein one or more ballistic sheets in the second stack of ballistic sheets is partially or fully bonded to an adjacent ballistic sheet in the stack of ballistic sheets;
a third structural member adjacent to the top surface of the second stack of ballistic sheets, the third structural member comprising a rigid carbon fiber composite material or a rigid fiberglass composite material; and
a fourth structural member adjacent to the bottom surface of the stack of ballistic sheets, the fourth structural member comprising a rigid carbon fiber composite material or a rigid fiberglass composite material, wherein the fourth structural member is joined to the third structural member to form a three-dimensional structural exterior layer that encapsulates the second stack of ballistic sheets, and wherein the distance between the inner door structure and the outer door structure is about 0.5-3, 2-6, 4-12, or 10-18 inches, the distance being at least two times greater than a length of a projectile the structural ballistic resistant door is intended to protect against.

8. A structural ballistic resistant vehicle door comprising:
a stack of ballistic sheets, the stack comprising a top surface and a bottom surface opposite the top surface, wherein one or more ballistic sheets in the stack of ballistic sheets are partially or fully bonded to an adjacent ballistic sheet in the stack of ballistic sheets;
a first structural member adjacent to the top surface of the stack of ballistic sheets, the first structural member comprising a rigid carbon fiber composite material or a rigid fiberglass composite material; and
a second structural member adjacent to the bottom surface of the stack of ballistic sheets, the second structural member comprising a rigid carbon fiber composite material or a rigid fiberglass composite material,
wherein the second structural member is joined to the first structural member to form a three-dimensional structural exterior layer that encapsulates the stack of ballistic sheets, and wherein the first and second structural members provide a compressive force against opposing exterior surfaces of the stack of ballistic sheets to resist delamination of the stack of ballistic sheets when the structural ballistic resistant vehicle door is struck by a projectile.

9. The structural ballistic resistant vehicle door of claim 8, wherein the stack of ballistic sheets comprises about 10-20, 20-100, at least 100, 180-220, 220-260, at least 260, 260-500, 500-1,000, or 1,000-1,200 ballistic sheets.

10. The structural ballistic resistant vehicle door of claim 8, wherein one or more ballistic sheets within the stack of ballistic sheets comprise aramid fibers arranged unilaterally, wherein the structural ballistic resistant vehicle door has a ballistic performance that meets or exceeds threat level III requirements set forth in NIJ Standard 0108.01.

11. The structural ballistic resistant vehicle door of claim 8, wherein one or more ballistic sheets within the stack of ballistic sheets comprise ultra-high-molecular-weight polyethylene having an average molecular weight between about two million and six million.

12. The structural ballistic resistant vehicle door of claim 8, further comprising a first film adhesive layer between the first structural member and the top surface of the stack of ballistic sheets, wherein the first film adhesive layer comprises a thermoplastic polymer.

13. The structural ballistic resistant vehicle door of claim 8, further comprising a ceramic member positioned between the first structural member and the top surface of the stack of ballistic sheets, the ceramic member comprising silicon carbide, boron carbide, titanium carbide, tungsten carbide, zirconia toughened alumina, or high-density aluminum oxide.

14. The structural ballistic resistant vehicle door of claim 8, further comprising a plurality of ceramic members arranged in an array between the first structural member and the top surface of the stack of ballistic sheets, wherein the structural ballistic resistant vehicle door has a ballistic performance that meets or exceeds threat level IV requirements set forth in NIJ Standard 0108.01.

15. A structural ballistic resistant vehicle door comprising:
an outer door structure, wherein the outer door structure comprises a rigid carbon fiber composite material or a rigid fiberglass composite material; and
an inner door structure joined to the outer door structure to form the structural ballistic resistant vehicle door, the inner door structure comprising:
a stack of ballistic sheets, the stack comprising a top surface and a bottom surface opposite the top surface, wherein one or more ballistic sheets in the stack of ballistic sheets is partially or fully bonded to an adjacent ballistic sheet in the stack of ballistic sheets;
a first structural member adjacent to the top surface of the stack of ballistic sheets, the first structural member comprising a rigid carbon fiber composite material or a rigid fiberglass composite material; and
a second structural member adjacent to the bottom surface of the stack of ballistic sheets, the second structural member comprising a rigid carbon fiber composite material or a rigid fiberglass composite material,
wherein the second structural member is joined to the first structural member to form a three-dimensional structural exterior layer that encapsulates the stack of ballistic sheets.

16. The structural ballistic resistant vehicle door of claim 15, wherein the stack of ballistic sheets comprises about 10-20, 20-100, at least 100, 180-220, 220-260, at least 260, 260-500, 500-1,000, or 1,000-1,200 ballistic sheets.

17. The structural ballistic resistant vehicle door of claim 15, wherein one or more ballistic sheets within the stack of ballistic sheets comprise ultra-high-molecular-weight polyethylene having an average molecular weight between about two million and six million.

18. The structural ballistic resistant vehicle door of claim 15, wherein one or more ballistic sheets within the stack of ballistic sheets comprise aramid fibers arranged unilaterally.

19. The structural ballistic resistant vehicle door of claim 15, further comprising:
a first film adhesive layer between the first structural member and the top surface of the stack of ballistic sheets, the first film adhesive layer comprising polyethylene, polypropylene, ethylene, copolyester, copolyamide, or thermoplastic polyurethane, the first film adhesive layer adhering the first structural member to the top surface of the stack of ballistic sheets; and
a second film adhesive layer between the second structural member and the bottom surface of the stack of ballistic sheets, the second film adhesive layer comprising polyethylene, polypropylene, ethylene, copolyester, copolyamide, or thermoplastic polyurethane, the first adhesive film layer adhering the second structural member to the bottom surface of the stack of ballistic sheets.

20. The structural ballistic resistant vehicle door of claim 15, wherein the outer door structure further comprises a ceramic member encased by a structural member, the structural member comprising woven or nonwoven carbon fiber fabric infused with a thermoset resin, wherein the structural ballistic resistant vehicle door has a ballistic performance that meets or exceeds threat level III requirements set forth in NIJ Standard 0108.01.
